(19) United States
(12) Patent Application Publication
(10) Pub. No.: US 2024/0322883 A1
(43) Pub. Date: Sep. 26, 2024

(54) CHANNEL STATE INFORMATION PROCESSING METHOD AND APPARATUS

(71) Applicant: HUAWEI TECHNOLOGIES CO., LTD., Shenzhen (CN)

(72) Inventors: Mengyuan Li, Shenzhen (CN); Rong Li, Boulogne Billancourt (FR); Jian Wang, Hangzhou (CN)

(73) Assignee: HUAWEI TECHNOLOGIES CO., LTD., Shenzhen (CN)

(21) Appl. No.: 18/666,833

(22) Filed: May 17, 2024

Related U.S. Application Data
(63) Continuation of application No. PCT/CN2022/130632, filed on Nov. 8, 2022.

(30) Foreign Application Priority Data
Nov. 18, 2021 (CN) 202111370355.6

(51) Int. Cl. H04B 7/06; H04B 17/391

(52) U.S. Cl. CPC H04B 7/0626; H04B 17/3913

(57) ABSTRACT

The disclosure provides a channel state information processing method and an apparatus related to the communication field. The channel state information processing method includes: a first communication apparatus determines a first graph model corresponding to first channel state information. The first channel state information is channel state information from a second communication apparatus to the first communication apparatus. Then, the first communication apparatus processes the first graph model through a first neural network, to obtain first information. The first information is for the second communication apparatus to restore the first channel state information. Finally, the first communication apparatus sends the first information to the second communication apparatus.

### CROSS-REFERENCE TO RELATED APPLICATIONS

This application is a continuation of International Application No. PCT/CN2022/130632, filed on Nov. 8, 2022, which claims priority to Chinese Patent Application No. 202111370355.6, filed on Nov. 18, 2021. The disclosures of the aforementioned applications are hereby incorporated by reference in their entireties.

### TECHNICAL FIELD

The disclosure relates to the communication field, and in particular, to a channel state information processing method and an apparatus.

### BACKGROUND

In a communication system, a terminal device needs to periodically or aperiodically report channel state information (CSI) to a network device. The CSI may include at least one CSI report, and the CSI report indicates channel state information of a downlink channel. For example, the terminal device may obtain and report the at least one CSI report by measuring a downlink reference signal sent by the network device. The network device may allocate a corresponding downlink transmission resource to the terminal device based on the CSI report reported by the terminal device.

Currently, a terminal device usually does not report actual CSI to a network device, but indicates a precoding matrix by using a precoding matrix indicator (PMI) transmitted in a CSI report, to implement precoding and downlink data transmission on a network device side. However, the precoding matrix indicated using the PMI is not a precoding matrix corresponding to the actual CSI. Consequently, a communication performance loss is caused.

### SUMMARY

Embodiments of the disclosure provide a channel state information processing method and an apparatus, to ensure validity of CSI feedback and improve communication performance.

To achieve the foregoing objective, the disclosure uses the following technical solutions.

According to a first aspect, the disclosure provides a channel state information processing method. The method is applicable to a first communication apparatus, and the first communication apparatus is, for example, a terminal device or a network device. The method includes: First, a first communication apparatus determines a first graph model corresponding to first channel state information. The first channel state information is channel state information from a second communication apparatus to the first communication apparatus. Then, the first communication apparatus processes the first graph model through a first neural network, to obtain first information. The first information is used by the second communication apparatus to restore the first channel state information. Finally, the first communication apparatus sends the first information to the second communication apparatus.

It can be learned from the method according to the first aspect that, in a process in which the first communication apparatus processes the first graph model through the first neural network, important feature information in the first graph model may be reserved, unimportant feature information in the first graph model is omitted, and the first channel state information is compressed through the first neural network, to reduce CSI feedback overheads and ensure effectiveness of CSI feedback, so that channel state information restored by the second communication apparatus is closer to that of an original channel, thereby improving communication performance.

In a possible implementation, that a first communication apparatus determines a first graph model corresponding to first channel state information includes: The first communication apparatus determines, based on transmit and receive antenna configuration information, the first graph model corresponding to the first channel state information. The transmit and receive antenna configuration information includes receive antenna configuration information of the first communication apparatus and transmit antenna configuration information of the second communication apparatus.

In a possible implementation, the first information includes auxiliary information, the auxiliary information is used to determine a second graph model, and the second graph model is used to restore the first channel state information. In other words, the auxiliary information may help the second communication apparatus restore the first channel state information, and improve accuracy of the first channel state information restored by the second communication apparatus.

Optionally, the auxiliary information includes index information of a part of nodes of the first graph model. It may be understood that, in a process in which the first communication apparatus processes the first graph model through the first neural network, the unimportant feature information in the first graph model is omitted, for example, feature information of a part of nodes in the first graph model is omitted. The first communication apparatus may indicate, by using the auxiliary information, a discarded node in the first graph model, or indicate, by using the auxiliary information, a reserved node in the first graph model. In this way, the accuracy of the first channel state information restored by the second communication apparatus can be improved.

Further, the auxiliary information may further include an average value of features of the part of nodes. In this way, this may further help the second communication apparatus restore the first channel state information, and improve the accuracy of the first channel state information restored by the second communication apparatus.

Optionally, the first information includes second channel state information and the auxiliary information, and the second channel state information includes processed first channel state information.

Further, the first neural network may include a first pooling layer and a compression layer. The first graph pooling layer is configured to determine a third graph model and the auxiliary information based on the first graph model, and the compression layer is configured to determine the second channel state information based on the third graph model. It may be understood that input of the first pooling layer may be graph models of different structures. To be specific, for the first communication apparatus and the second communication apparatus (collectively referred to as two ends for receiving and transmitting CSI below) with different antenna configurations, the first communication apparatus may determine the first graph model corresponding to the first channel state information, and input the first graph model into the same first neural network. In other words, design and training that are of the first neural network do not depend on the antenna configurations of the two ends for receiving and transmitting the CSI. In this way, when the antenna configurations of the two ends for receiving and transmitting the CSI change, the neural network may be avoided from being redesigned and trained, and the neural network is applicable to a dynamic multiple-input multiple-output (MIMO) system or a plurality of MIMO systems with different antenna configurations.

The first graph pooling layer may be a graph pooling layer using a self-attention mechanism. Because a small quantity of parameters of the graph pooling layer using the self-attention mechanism need to be trained, and feature information of a node in the first graph model and topology structure information of a graph can be fully extracted, training efficiency and a processing capability that are of the neural network can be improved.

Further, the first neural network may include a first graph convolutional layer, a first graph pooling layer, and a compression layer. The first graph convolutional layer is configured to determine a convolved first graph model based on the first graph model, the first graph pooling layer is configured to determine a third graph model and the auxiliary information based on the convolved first graph model, and the compression layer is configured to determine the second channel state information based on the third graph model. In other words, design and training that are of the first neural network do not depend on the antenna configurations of the two ends for receiving and transmitting the CSI. In this way, when the antenna configurations of the two ends for receiving and transmitting the CSI change, the neural network may be avoided from being redesigned and trained, and the neural network is applicable to a dynamic MIMO system or a plurality of MIMO systems with different antenna configurations.

Further, the compression layer may be a fully coupled layer.

In a possible implementation, the first channel state information includes delay-angle domain channel state information between a transmit antenna of the second communication apparatus and a receive antenna of the first communication apparatus. The delay-angle domain channel state information includes channel state information between R receiving angles and T transmitting angles, R and T are both positive integers, and at least one of R and T is greater than 1. The first graph model includes a plurality of nodes, a feature of the node includes channel state information between an i^{th} transmitting angle and a j^{th} receiving angle, 1≤i≤T, and 1≤j≤R. The first graph model further includes at least one edge. Each edge is coupled to two nodes, and each edge indicates that the two nodes coupled to the edge correspond to two adjacent receiving angles or two adjacent transmitting angles.

Optionally, the channel state information included in the feature of each node includes C elements in time domain, and C is less than or equal to a quantity of subcarriers. Because the channel state information is sparse in time domain, a quantity of elements included in the channel state information included in the feature of each node in time domain is appropriately reduced, and accuracy of the CSI is not affected. In other words, when C is less than the quantity of subcarriers, a data processing amount of the communication apparatus can be reduced without affecting accurate restoration of the first channel state information by the second communication apparatus, and a processing rate of the communication apparatus can be increased.

In a possible implementation, the receive antenna configuration information of the first communication apparatus includes one or more of the following: a quantity of receive antennas of the first communication apparatus, a type of a receive antenna panel, and an arrangement manner of receive antenna units. The transmit antenna configuration information of the second communication apparatus includes one or more of the following: a quantity of transmit antennas of the second communication apparatus, a type of a transmit antenna panel, and an arrangement manner of transmit antenna units.

In a possible implementation, that the first communication apparatus determines the first channel state information includes: The first communication apparatus determines the first channel state information based on space-frequency domain channel state information between the transmit antenna of the second communication apparatus and the receive antenna of the first communication apparatus. The first channel state information is delay-angle domain channel state information.

In a possible implementation, the first neural network is determined based on a training dataset, the training dataset includes a plurality of pieces of fourth channel state information for the first neural network, and the fourth channel state information is channel state information from the second communication apparatus to the first communication apparatus.

According to a second aspect, the disclosure provides a channel state information processing method. The method is applicable to a second communication apparatus, and the second communication apparatus is, for example, a network device or a terminal device. The method includes: First, a second communication apparatus receives first information sent by a first communication apparatus. The first information is used by the second communication apparatus to restore first channel state information, and the first channel state information is channel state information from the second communication apparatus to the first communication apparatus. Then, the second communication apparatus processes the first information through a second neural network, to obtain a second graph model. Finally, the second communication apparatus determines third channel state information based on the second graph model. The third channel state information is the restored first channel state information.

In a possible implementation, that the second communication apparatus determines third channel state information based on the second graph model includes: The second communication apparatus determines a third channel state based on the second graph model and transmit and receive antenna configuration information. The transmit and receive antenna configuration information includes receive antenna configuration information of the first communication apparatus and transmit antenna configuration information of the second communication apparatus.

In a possible implementation, the first information includes auxiliary information, and the auxiliary information is used to determine the second graph model.

Optionally, the auxiliary information includes index information of a part of nodes of a first graph model, and the first graph model is a graph model corresponding to the first channel state information.

Further, the auxiliary information may further include an average value of features of the part of nodes.

Optionally, the first information includes second channel state information and the auxiliary information, and the second channel state information includes processed first channel state information.

Further, the second neural network may include a decompression layer and a second graph convolutional layer. The decompression layer is configured to determine a fourth graph model based on the second channel state information, and the second graph convolutional layer is configured to determine the second graph model based on the auxiliary information and the fourth graph model.

Further, the second graph convolutional layer may include a plurality of graph convolutional layers, and a direct coupling channel is included between the plurality of graph convolutional layers. In this way, training efficiency and stability that are of the neural network can be improved.

Further, the decompression layer may be a fully coupled layer.

In a possible implementation, the first channel state information includes delay-angle domain channel state information between a transmit antenna of the second communication apparatus and a receive antenna of the first communication apparatus. The delay-angle domain channel state information includes channel state information between R receiving angles and T transmitting angles, R and T are both positive integers, and at least one of R and T is greater than 1. The second graph model includes a plurality of nodes, a feature of the node includes channel state information between an i^{th} transmitting angle and a j^{th} receiving angle, 1≤i≤T, and 1≤j≤R. The second graph model further includes at least one edge. Each edge is coupled to two nodes, and each edge indicates that the two nodes coupled to the edge correspond to two adjacent receiving angles or two adjacent transmitting angles.

Optionally, the channel state information included in the feature of each node includes C elements in time domain, and C is less than or equal to a quantity of subcarriers.

In a possible implementation, the receive antenna configuration information of the first communication apparatus includes one or more of the following: a quantity of receive antennas of the first communication apparatus, a type of a receive antenna panel, and an arrangement manner of receive antenna units. The transmit antenna configuration information of the second communication apparatus includes one or more of the following: a quantity of transmit antennas of the second communication apparatus, a type of a transmit antenna panel, and an arrangement manner of transmit antenna units.

In a possible implementation, the second neural network is determined based on a training dataset, the training dataset includes a plurality of pieces of fourth channel state information for the second neural network, and the fourth channel state information is channel state information from the second communication apparatus to the first communication apparatus.

In addition, for a technical effect of the method according to the second aspect, refer to the technical effect of the method according to the first aspect. Details are not described herein again.

According to a third aspect, a first communication apparatus is provided. The first communication apparatus includes a processing module and a transceiver module. The processing module is configured to determine a first graph model corresponding to first channel state information, the first channel state information is channel state information from a second communication apparatus to the first communication apparatus. The processing module is further configured to process the first graph model through a first neural network, to obtain first information, and the first information is used by the second communication apparatus to restore the first channel state information. The transceiver module is configured to send the first information to the second communication apparatus.

In a possible implementation, the processing module is further configured to determine, based on transmit and receive antenna configuration information, the first graph model corresponding to the first channel state information. The transmit and receive antenna configuration information includes receive antenna configuration information of the first communication apparatus and transmit antenna configuration information of the second communication apparatus.

In a possible implementation, the first information includes auxiliary information, the auxiliary information is used to determine a second graph model, and the second graph model is used to restore the first channel state information.

Optionally, the auxiliary information includes index information of a part of nodes of the first graph model.

Further, the auxiliary information may further include an average value of features of the part of nodes.

Optionally, the first information includes second channel state information and the auxiliary information, and the second channel state information includes processed first channel state information.

Further, the first neural network may include a first pooling layer and a compression layer. The first graph pooling layer is configured to determine a third graph model and the auxiliary information based on the first graph model, and the compression layer is configured to determine the second channel state information based on the third graph model.

The first graph pooling layer may be a graph pooling layer using a self-attention mechanism.

Further, the first neural network may include a first graph convolutional layer, a first graph pooling layer, and a compression layer. The first graph convolutional layer is configured to determine a convolved first graph model based on the first graph model, the first graph pooling layer is configured to determine a third graph model and the auxiliary information based on the convolved first graph model, and the compression layer is configured to determine the second channel state information based on the third graph model.

Further, the compression layer may be a fully coupled layer.

In a possible implementation, the first channel state information includes delay-angle domain channel state information between a transmit antenna of the second communication apparatus and a receive antenna of the first communication apparatus. The delay-angle domain channel state information includes channel state information between R receiving angles and T transmitting angles, R and T are both positive integers, and at least one of R and T is greater than 1. The first graph model includes a plurality of nodes, a feature of the node includes channel state information between an i^{th} transmitting angle and a j^{th} receiving angle, 1≤i≤T, and 1≤j≤R. The first graph model further includes at least one edge. Each edge is coupled to two nodes, and each edge indicates that the two nodes coupled to the edge correspond to two adjacent receiving angles or two adjacent transmitting angles.

Optionally, the channel state information included in the feature of each node includes C elements in time domain, and C is less than or equal to a quantity of subcarriers.

In a possible implementation, the receive antenna configuration information of the first communication apparatus includes one or more of the following: a quantity of receive antennas of the first communication apparatus, a type of a receive antenna panel, and an arrangement manner of receive antenna units. The transmit antenna configuration information of the second communication apparatus includes one or more of the following: a quantity of transmit antennas of the second communication apparatus, a type of a transmit antenna panel, and an arrangement manner of transmit antenna units.

In a possible implementation, the processing module is further configured to determine the first channel state information based on space-frequency domain channel state information between the transmit antenna of the second communication apparatus and the receive antenna of the first communication apparatus. The first channel state information is delay-angle domain channel state information.

In a possible implementation, the first neural network is determined based on a training dataset, the training dataset includes a plurality of pieces of fourth channel state information for the first neural network, and the fourth channel state information is channel state information from the second communication apparatus to the first communication apparatus.

Optionally, the transceiver module may include a receiving module and a sending module. The receiving module is configured to implement a receiving function of the first communication apparatus according to the third aspect, and the sending module is configured to implement a sending function of the first communication apparatus according to the third aspect.

Optionally, the first communication apparatus in the third aspect may further include a storage module, and the storage module stores a program or instructions. When the processing module executes the program or the instructions, the first communication apparatus may perform the method according to the first aspect.

It should be noted that the first communication apparatus in the third aspect may be a terminal device or a network device, or may be a chip (system) or another part or component disposed in the terminal device or the network device, or may be a communication apparatus including the terminal device or the network device. This is not limited in the disclosure.

In addition, for a technical effect of the first communication apparatus according to the third aspect, refer to the technical effect of the method according to the first aspect. Details are not described herein again.

According to a fourth aspect, a second communication apparatus is provided. The second communication apparatus includes a processing module and a transceiver module. The transceiver module is configured to receive first information sent by a first communication apparatus. The first information is used by the second communication apparatus to restore first channel state information, and the first channel state information is channel state information from the second communication apparatus to the first communication apparatus. The processing module is configured to process the first information through a second neural network, to obtain a second graph model. The processing module is further configured to determine third channel state information based on the second graph model. The third channel state information is the restored first channel state information.

In a possible implementation, the processing module is further configured to determine a third channel state based on the second graph model and transmit and receive antenna configuration information. The transmit and receive antenna configuration information includes receive antenna configuration information of the first communication apparatus and transmit antenna configuration information of the second communication apparatus.

In a possible implementation, the first information includes auxiliary information, and the auxiliary information is used to determine the second graph model.

Optionally, the auxiliary information includes index information of a part of nodes of a first graph model, and the first graph model is a graph model corresponding to the first channel state information.

Further, the auxiliary information may further include an average value of features of the part of nodes.

Optionally, the first information includes second channel state information and the auxiliary information, and the second channel state information includes processed first channel state information.

Further, the second neural network may include a decompression layer and a second graph convolutional layer. The decompression layer is configured to determine a fourth graph model based on the second channel state information, and the second graph convolutional layer is configured to determine the second graph model based on the auxiliary information and the fourth graph model.

Further, the second graph convolutional layer may include a plurality of graph convolutional layers, and a direct coupling channel is included between the plurality of graph convolutional layers.

Further, the decompression layer may be a fully coupled layer.

In a possible implementation, the first channel state information includes delay-angle domain channel state information between a transmit antenna of the second communication apparatus and a receive antenna of the first communication apparatus. The delay-angle domain channel state information includes channel state information between R receiving angles and T transmitting angles, R and T are both positive integers, and at least one of R and T is greater than 1. The second graph model includes a plurality of nodes, a feature of the node includes channel state information between an i^{th} transmitting angle and a j^{th} receiving angle, 1≤i≤T, and 1≤j≤R. The second graph model further includes at least one edge. Each edge is coupled to two nodes, and each edge indicates that the two nodes coupled to the edge correspond to two adjacent receiving angles or two adjacent transmitting angles.

Optionally, the channel state information included in the feature of each node includes C elements in time domain, and C is less than or equal to a quantity of subcarriers.

In a possible implementation, the receive antenna configuration information of the first communication apparatus includes one or more of the following: a quantity of receive antennas of the first communication apparatus, a type of a receive antenna panel, and an arrangement manner of receive antenna units. The transmit antenna configuration information of the second communication apparatus includes one or more of the following: a quantity of transmit antennas of the second communication apparatus, a type of a transmit antenna panel, and an arrangement manner of transmit antenna units.

In a possible implementation, the second neural network is determined based on a training dataset, the training dataset includes a plurality of pieces of fourth channel state information for the second neural network, and the fourth channel state information is channel state information from the second communication apparatus to the first communication apparatus.

Optionally, the transceiver module may include a receiving module and a sending module. The receiving module is configured to implement a receiving function of the second communication apparatus according to the fourth aspect, and the sending module is configured to implement a sending function of the second communication apparatus according to the fourth aspect.

Optionally, the second communication apparatus in the fourth aspect may further include a storage module, and the storage module stores a program or instructions. When the processing module executes the program or the instructions, the second communication apparatus may perform the method according to the second aspect.

It should be noted that the second communication apparatus in the fourth aspect may be a network device or a terminal device, or may be a chip (system) or another part or component disposed in the network device or the terminal device, or may be a communication apparatus including the network device or the terminal device. This is not limited in the disclosure.

In addition, for a technical effect of the second communication apparatus according to the fourth aspect, refer to the technical effect of the method according to the second aspect. Details are not described herein again.

According to a fifth aspect, a communication apparatus is provided. The communication apparatus is configured to perform the channel state information processing method according to any implementation of the first aspect and the second aspect.

In the disclosure, the communication apparatus in the fifth aspect may be the first communication apparatus or the second communication apparatus, or may be a chip (system) or another part or component disposed in the first communication apparatus or the second communication apparatus, or may be a communication apparatus including the first communication apparatus or the second communication apparatus. This is not limited in the disclosure. The first communication apparatus is configured to perform the channel state information processing method according to any possible implementation of the first aspect, and the second communication apparatus is configured to perform the channel state information processing method according to any possible implementation of the second aspect.

It should be understood that the communication apparatus in the fifth aspect includes a corresponding module, unit, or means for implementing the channel state information processing method according to any one of the first aspect and the second aspect. The module, unit, or means may be implemented by hardware, or may be implemented by software, or may be implemented by hardware executing corresponding software. The hardware or software includes one or more modules or units configured to perform functions related to the foregoing channel state information processing method.

According to a sixth aspect, a communication apparatus is provided. The communication apparatus includes a processor, and the processor is configured to perform the channel state information processing method according to any possible implementation of the first aspect and the second aspect.

In a possible implementation, the communication apparatus in the sixth aspect may further include a transceiver. The transceiver may be a transceiver circuit or an interface circuit. The transceiver may be used by the communication apparatus in the sixth aspect to communicate with another communication apparatus.

In a possible implementation, the communication apparatus in the sixth aspect may further include a memory. The memory may be integrated with the processor, or may be disposed separately. The memory may be configured to store a computer program and/or data related to the channel state information processing method according to any one of the first aspect and the second aspect.

In the disclosure, the communication apparatus in the sixth aspect may be the first communication apparatus or the second communication apparatus, or may be a chip (system) or another part or component disposed in the first communication apparatus or the second communication apparatus, or may be a communication apparatus including the first communication apparatus or the second communication apparatus. This is not limited in the disclosure. The first communication apparatus is configured to perform the channel state information processing method according to any possible implementation of the first aspect, and the second communication apparatus is configured to perform the channel state information processing method according to any possible implementation of the second aspect.

According to a seventh aspect, a communication apparatus is provided. The communication apparatus includes a processor. The processor is coupled to a memory, and the processor is configured to execute a computer program stored in the memory, to enable the communication apparatus to perform the channel state information processing method according to any possible implementation of the first aspect and the second aspect.

In a possible implementation, the communication apparatus in the seventh aspect may further include a transceiver. The transceiver may be a transceiver circuit or an interface circuit. The transceiver may be used by the communication apparatus in the seventh aspect to communicate with another communication apparatus.

In the disclosure, the communication apparatus in the seventh aspect may be the first communication apparatus or the second communication apparatus, or may be a chip (system) or another part or component disposed in the first communication apparatus or the second communication apparatus, or may be a communication apparatus including the first communication apparatus or the second communication apparatus. This is not limited in the disclosure. The first communication apparatus is configured to perform the channel state information processing method according to any possible implementation of the first aspect, and the second communication apparatus is configured to perform the channel state information processing method according to any possible implementation of the second aspect.

According to an eighth aspect, a communication apparatus is provided. The communication apparatus includes a processor and an interface circuit. The interface circuit is configured to receive code instructions and transmit the code instructions to the processor. The processor is configured to run the code instructions to perform the channel state information processing method according to any implementation of the first aspect and the second aspect.

In a possible implementation, the communication apparatus in the eighth aspect may further include a memory. The memory may be integrated with the processor, or may be disposed separately. The memory may be configured to store a computer program and/or data related to the channel state information processing method according to any one of the first aspect and the second aspect.

In the disclosure, the communication apparatus in the eighth aspect may be the first communication apparatus or the second communication apparatus, or may be a chip (system) or another part or component disposed in the first communication apparatus or the second communication apparatus, or may be a communication apparatus including the first communication apparatus or the second communication apparatus. This is not limited in the disclosure. The first communication apparatus is configured to perform the channel state information processing method according to any possible implementation of the first aspect, and the second communication apparatus is configured to perform the channel state information processing method according to any possible implementation of the second aspect.

According to a ninth aspect, a communication apparatus is provided. The communication apparatus includes a processor and a storage medium. The storage medium stores instructions. When the instructions are run by the processor, the channel state information processing method according to any possible implementation of the first aspect and the second aspect is implemented.

In the disclosure, the communication apparatus in the ninth aspect may be the first communication apparatus or the second communication apparatus, or may be a chip (system) or another part or component disposed in the first communication apparatus or the second communication apparatus, or may be a communication apparatus including the first communication apparatus or the second communication apparatus. This is not limited in the disclosure. The first communication apparatus is configured to perform the channel state information processing method according to any possible implementation of the first aspect, and the second communication apparatus is configured to perform the channel state information processing method according to any possible implementation of the second aspect.

According to a tenth aspect, a processor is provided. The processor is configured to perform the channel state information processing method according to any possible implementation of the first aspect and the second aspect.

According to an eleventh aspect, a communication system is provided. The communication system includes a first communication apparatus or a second communication apparatus. The first communication apparatus is configured to perform the channel state information processing method according to any possible implementation of the first aspect, and the second communication apparatus is configured to perform the channel state information processing method according to any possible implementation of the second aspect.

According to a twelfth aspect, a computer-readable storage medium is provided. The computer-readable storage medium includes a computer program or instructions. When the computer program or the instructions are run by a processor, the channel state information processing method according to any possible implementation of the first aspect and the second aspect is implemented.

According to a thirteenth aspect, a computer program product is provided. The computer program product includes instructions. When the instructions are run by a processor, the channel state information processing method according to any possible implementation of the first aspect and the second aspect is implemented.

According to a fourteenth aspect, a chip is provided. The chip includes a processing logic circuit and an interface circuit. There may be one or more processing logic circuits, and there may be a plurality of interface circuits.

The interface circuit is configured to receive code instructions and transmit the code instructions to the processing logic circuit. The processing logic circuit is configured to run the code instructions to perform the channel state information processing method according to any implementation of the first aspect and the second aspect.

Optionally, the chip may include a memory, and the memory may be integrated with the processing logic circuit or may be disposed separately. The memory may be configured to store a computer program and/or data related to the channel state information processing method according to any one of the first aspect and the second aspect.

In the disclosure, the chip in the fourteenth aspect may be located in a first communication apparatus or a second communication apparatus, or may be located in a first communication apparatus or a second communication apparatus in a communication system. When the chip is located in the first communication apparatus, the chip is configured to perform the channel state information processing method according to any possible implementation of the first aspect. When the chip is located in the second communication apparatus, the chip is configured to perform the channel state information processing method according to any possible implementation of the second aspect.

For technical effects brought by any implementation of the fifth aspect to the fourteenth aspect, refer to technical effects brought by any implementation corresponding to the first aspect and the second aspect. Details are not described herein again.

In the disclosure, based on the implementations in the foregoing aspects, the implementations may be further combined to provide more implementations.

### BRIEF DESCRIPTION OF DRAWINGS

FIG. 1 is a schematic diagram of single-panel antenna configurations according to an embodiment of the disclosure;

FIG. 2 is a schematic diagram of a multi-panel antenna configuration according to an embodiment of the disclosure;

FIG. 3 is a schematic diagram of a fully coupled neural network according to an embodiment of the disclosure;

FIG. 4 is a schematic diagram of optimization of a loss function according to an embodiment of the disclosure;

FIG. 5 is a schematic diagram of gradient backpropagation according to an embodiment of the disclosure;

FIG. 6 is a schematic diagram of a hierarchical structure of a graph neural network according to an embodiment of the disclosure;

FIG. 7 is a schematic diagram of an architecture of a communication system according to an embodiment of the disclosure;

FIG. 8 is a schematic diagram of a structure of a communication apparatus according to an embodiment of the disclosure;

FIG. 9 is a schematic interaction diagram of a channel state information processing method according to an embodiment of the disclosure;

FIG. 10 is a schematic diagram of a first subgraph model according to an embodiment of the disclosure;

FIG. 11 is a schematic diagram of coupling between transmit and receive antennas according to an embodiment of the disclosure;

FIG. 12 is a schematic diagram 1 of a first graph model according to an embodiment of the disclosure;

FIG. 13 is a schematic diagram 2 of a first graph model according to an embodiment of the disclosure;

FIG. 14 is a schematic diagram 1 of a structure of a neural network according to an embodiment of the disclosure;

FIG. 15 is a schematic diagram 2 of a structure of a neural network according to an embodiment of the disclosure;

FIG. 16 is a schematic diagram 3 of a structure of a neural network according to an embodiment of the disclosure;

FIG. 17 is a schematic diagram 4 of a structure of a neural network according to an embodiment of the disclosure; and

FIG. 18 is a schematic diagram of a structure of a communication apparatus according to an embodiment of the disclosure.

### DESCRIPTION OF EMBODIMENTS

For ease of understanding the solutions in embodiments of the disclosure, brief descriptions of a conventional technology are first provided.

### 1. Precoding in a MIMO System

In a communication system, a MIMO technology is usually used to increase a system capacity, in other words, a plurality of antennas are simultaneously used for communication at a transmit end and a receive end. Theoretically, use of the plurality of antennas in combination with spatial division multiplexing can multiply the system capacity and increase a communication rate. However, the use of the plurality of antennas also causes interference enhancement. Therefore, signals need to be processed to suppress an impact caused by interference. This method for suppressing interference through signal processing may be implemented at the receive end, or may be implemented at the transmit end. During implementation at the transmit end, the transmit end may preprocess a to-be-sent signal, and then send the to-be-sent signal through a MIMO channel. This manner is referred to as precoding. The following provides descriptions of precoding.

To identify a useful channel in a channel matrix (denoted as a channel matrix H), a plurality of channels need to be converted into a mode that is similar to a one-to-one mode of a single input single output (SISO) system, in other words, a plurality of MIMO cross channels are converted into a plurality of parallel one-to-one channels. This process may be implemented through singular value decomposition (SVD) of the channel matrix. A formula of the SVD is H=UΣV^{T}, where U and V are orthogonal matrices, Σ is a diagonal matrix, an element on a diagonal in Σ is a singular value, and a superscript T represents a transposition operation. On this basis, assuming that s is a transmit signal, n is a noise, and r is a receive signal, r=H*s+n may be converted into r=UΣVT*s+n. In other words, if to-be-sent data is x, s=Vx may be used to process the data. In this way, the receive end may perform decoding by using Σ⁻¹U^{T}, to obtain a plurality of interference-free one-to-one channels. A process in which the transmit end processes the data by using s=Vx is a precoding operation, and V is a precoding matrix.

Usually, the singular value decomposition needs to be performed based on complete H, to obtain the corresponding precoding matrix V. However, in an actual communication system, because a data amount of actual CSI is very large, if a terminal device reports the actual CSI to a network device, high transmission overheads are caused. In this case, a standard provides a series of V matrices, namely, codebooks, and a proper precoding matrix is selected from the V matrices through coordination between the transmit end and the receive end. Specifically, the current terminal device usually does not report the actual CSI to the network device, but the terminal device indicates, by feeding back a PMI, one V that can make H have a maximum capacity in the codebooks provided and specified in the standard, to implement precoding processing on the network device side. This manner is equivalent to implicitly indicating the actual CSI. V indicated using the PMI is not a precoding matrix corresponding to the actual CSI. Consequently, a performance loss is caused.

### 2. Antenna Panel type

On a hardware device in a MIMO system, the antenna panel type may include a single-panel type and a multi-panel type. The following describes the foregoing two types respectively.

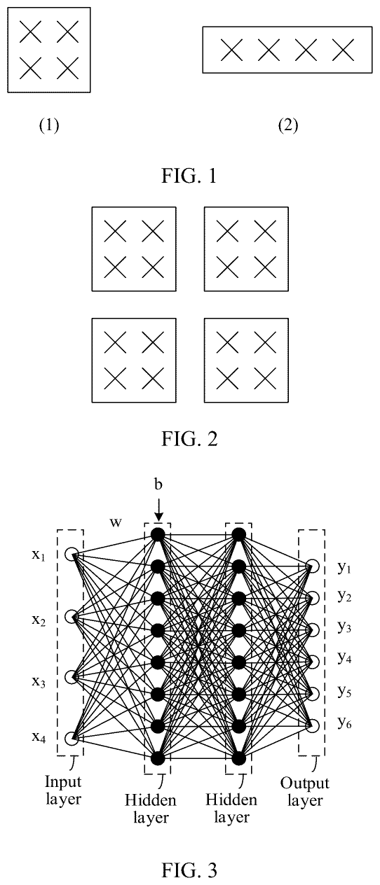

Single-panel: Refer to FIG. 1. FIG. 1 is a schematic diagram of single-panel antenna

configurations according to an embodiment of the disclosure. It is assumed that N₁ is a quantity of horizontally polarized antenna pairs on an antenna panel, and N₂ is a quantity of vertically polarized antenna pairs on the antenna panel. In this case, a single-panel antenna configuration shown in (1) in FIG. 1 is (N₁,N₂)=(2,2), and a single-panel antenna configuration shown in (2) in FIG. 1 is (N₁,N₂)=(4,1).

Multi-panel: Refer to FIG. 2. FIG. 2 is a schematic diagram of a multi-panel antenna configuration according to an embodiment of the disclosure. It is assumed that N_{g} is a quantity of antenna panels, and N₁ and N₂ are respectively a quantity of horizontally polarized antenna pairs and a quantity of vertically polarized antenna pairs on a single antenna panel. In this case, the multi-panel antenna configuration shown in FIG. 2 is (N_{g},N₁,N₂)=(4,2,2).

### 3. Fully Coupled Neural Network

The fully coupled neural network is also referred to as multilayer perceptron (multilayer perceptron, MLP). Refer to FIG. 3. FIG. 3 is a schematic diagram of a fully coupled neural network according to an embodiment of the disclosure. One MLP may include one input layer (including x₁ to x₄ in FIG. 3), one output layer (including y₁ to y₆ in FIG. 3), and a plurality of hidden layers. Each hidden layer may include several nodes (black circles in FIG. 3), which are referred to as neurons. Neurons at two adjacent layers are coupled in pairs. The following briefly describes an implementation principle of the fully coupled neural network.

Neurons at two adjacent layers are used as an example. An output h of a neuron at a lower layer is a weighted sum of outputs of all neurons x at an upper layer that are coupled to the neuron at the lower layer and that pass through an activation function. For representation using a matrix, refer to the following formula:

$$h = f ( wx + b ) .$$

x is a neuron, w is a weight matrix, b is a bias vector, and f is an activation function. Based on this, it can be obtained that an output recursive expression of the neural network is:

$$y = {f}_{n} ( {w}_{n} {f}_{n - 1} ( … ) + {b}_{n} ) .$$

In short, the neural network may be understood as a mapping relationship from an input dataset to an output dataset. Usually, the neural network is randomly initialized, in other words, w and b are random numbers. A process of obtaining the mapping relationship from random w and b based on existing data is referred to as training of the neural network.

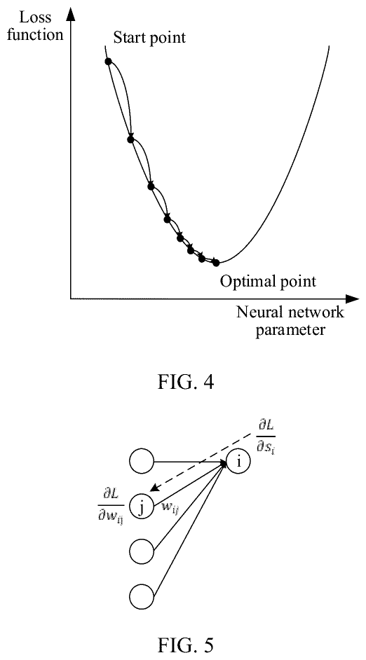

A specific training manner may include: evaluating an output result of the neural network according to a loss function, backpropagating a gradient, and iteratively optimizing w and b in a gradient descent method until the loss function reaches a minimum value. Refer to FIG. 4. FIG. 4 is a schematic diagram of optimization of a loss function according to an embodiment of the disclosure. An expression of a gradient descent process may be as follows:

$$θ ← θ - η \frac{\partial L}{\partial θ} .$$

θ is a to-be-optimized parameter (for example, w and b), L is the loss function, η is a learning rate, and η may be used to control a gradient descent step. A backpropagation process may be implemented using a chain rule for obtaining a partial derivative, to be specific, a gradient of a parameter of a previous layer may be recursively calculated from a gradient of a parameter of a subsequent layer. Refer to FIG. 5. FIG. 5 is a schematic diagram of gradient backpropagation according to an embodiment of the disclosure. A formula of the gradient backpropagation may be expressed as:

$$\frac{\partial L}{\partial {w}_{ij}} = \frac{\partial L}{\partial {s}_{i}} \frac{\partial {s}_{i}}{\partial {w}_{ij}} .$$

L is a loss function, wᵢⱼ is a weight of an edge connecting a node i to a node j (that is, a neuron in FIG. 3), and sᵢ is a weighted sum of inputs on the node i.

### 4. Graph Neural Network (GNN)

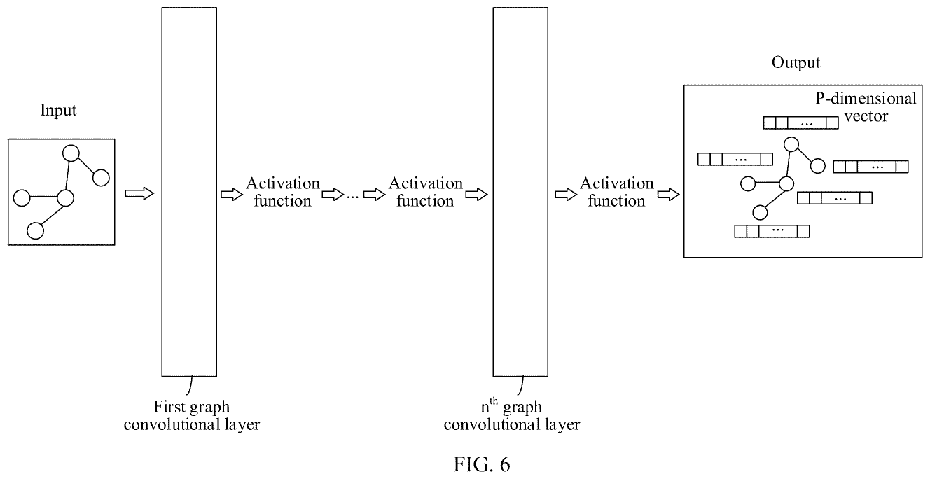

The GNN is a neural network model specially proposed for graph data (collectively referred to as graph models below), and has a good feature independent of a graph scale, that is, the same GNN may process graph models of different structures and/or different scales. As shown in FIG. 6, FIG. 6 is a schematic diagram of a hierarchical structure of a GNN according to an embodiment of the disclosure. In the GNN, a graph model is used as an input of the GNN, and an output of the GNN is represented using a p-dimensional vector of a graph, a node, an edge, or a subgraph. A graph convolution operation may be performed at each layer of the GNN, for example, a first graph convolutional layer in FIG. 6. Similar to a conventional convolution operation, the graph convolution operation may be considered as an aggregation operation performed on adjacent node information, and a formula may be expressed as follows:

$${μ}_{v}^{( k )} = {Agg}^{( k )} ( {x}_{v} , {μ}_{N ( v )}^{( k - 1 )} ; θ ) ,$$

k represents a k^{th} graph convolutional layer, Xᵥ represents a feature of a node v, μ_{N(v)}^{(k-1)}

represents hidden layer state information of an upper layer ((k−1)ₜₕ layer) at which an adjacent node of the node v, Agg^{(k)}(·,·;θ) represents an aggregation function of the k^{th} layer, the aggregation function is shared by all nodes, and θ is a to-be-trained parameter. In this way, through graph convolution operations at a plurality of layers, a node can continuously aggregate adjacent node information based on a topology structure, and update a feature of the node.

Based on the foregoing brief description, it can be learned that, a current terminal device usually does not report actual CSI to a network device, but indicates a precoding matrix by using a PMI in a CSI report, to implement selection of a precoding matrix. The precoding matrix indicated using the PMI is not a precoding matrix corresponding to the actual CSI. Consequently, a performance loss is caused. Therefore, how to transmit the actual CSI becomes an urgent problem to be resolved.

To resolve the foregoing problem, embodiments of the disclosure provide technical solutions. The technical solutions include a communication system, a channel state information processing method applied to the communication system, a communication apparatus, and the like. The following describes the technical solutions provided in the disclosure with reference to the accompanying drawings.

The technical solutions in embodiments of the disclosure are applicable to a wireless communication system. For example, the wireless communication system may be a 4th generation (4G) communication system (for example, a long term evolution (LTE) system), a 5th generation (5G) communication system (for example, a new radio (NR) system), a mobile communication system evolved after 5G (for example, a 6G communication system), or a narrowband internet of things (NB-IoT) system. The technical solutions in embodiments of the disclosure are further applicable to a satellite communication system or a non-terrestrial communication network (NTN) communication system. The satellite communication system or the NTN communication system may be integrated with the wireless communication system. The technical solutions in embodiments of the disclosure are further applicable to an inter-satellite link communication system, a wireless projection system, a virtual reality (VR) communication system, an integrated access and backhaul (IAB) system, a wireless fidelity (Wi-Fi) communication system, an optical communication system, and the like. This is not limited herein.

All aspects, embodiments, or features are presented in the disclosure by describing a system that may include a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be used.

In addition, in embodiments of the disclosure, the word such as “example” or “for example” is used to represent giving an example, an illustration, or a description. Any embodiment or design scheme described as an “example” in the disclosure should not be explained as being more preferred or having more advantages than another embodiment or design scheme. Specifically, the term “example” is used to present a concept in a specific manner.

A network architecture and a service scenario described in embodiments of the disclosure are intended to describe the technical solutions in embodiments of the disclosure more clearly, and do not constitute a limitation on the technical solutions provided in embodiments of the disclosure. A person of ordinary skill in the art may know that: With the evolution of the network architecture and the emergence of new service scenarios, the technical solutions provided in embodiments of the disclosure are also applicable to similar technical problems.

An embodiment of the disclosure provides a communication system. The communication system is applicable to communication between a first communication apparatus and a second communication apparatus. The communication system provided in embodiments of the disclosure may include one or more first communication apparatuses and one or more second communication apparatuses. A quantity of first communication apparatuses and a quantity of second communication apparatuses in the communication system are not limited in embodiments of the disclosure. The first communication apparatus is, for example, a terminal device or a network device, and the second communication apparatus is, for example, a network device or a terminal device. In embodiments of the disclosure, an example in which the first communication apparatus is a terminal device and the second communication apparatus is a network device is used to describe the solutions provided in embodiments of the disclosure. This is uniformly described herein, and details are not described below again.

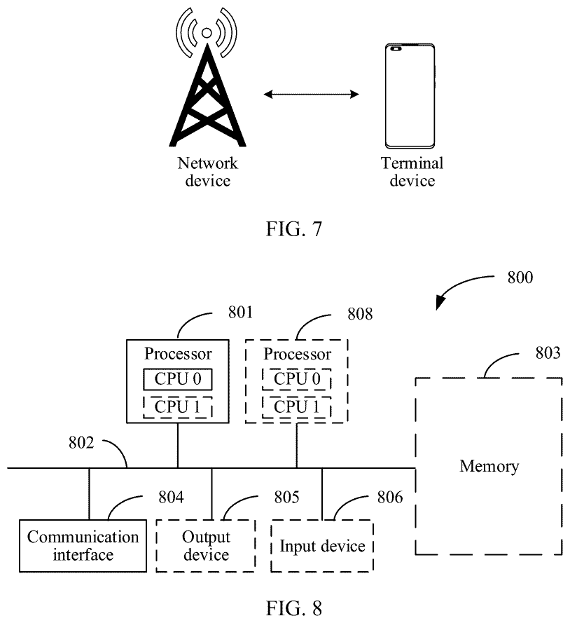

In an example, FIG. 7 is a schematic diagram of an architecture of a communication system according to an embodiment of the disclosure. As shown in FIG. 7, the communication system may include a network device and a terminal device, and the network device and the terminal device may be coupled in a wireless manner. The network device and the terminal device may exchange data, control signaling, and/or the like.

Optionally, the network device in embodiments of the disclosure is a device for connecting the terminal device to a wireless network. The network device may be a node in a radio access network, or may be referred to as a base station, or may be referred to as a radio access network (RAN) node (or device). The base station may be a distributed antenna system, and a radio frequency head end of the base station may communicate with a specific terminal device. For example, the network device may include an evolved NodeB (evolved NodeB, eNB, or eNodeB) in an LTE system or an LTE-advanced (LTE-A) system, for example, a conventional macro base station eNB and a micro base station eNB in a heterogeneous network scenario; or may include a next generation NodeB (gNB) in a 5G NR system, or may further include a transmission reception point (TRP), a transmission point (TP), a home base station (for example, home evolved NodeB, or home NodeB, HNB), a baseband unit (BBU), a baseband pool BBU pool, or a Wi-Fi access point (AP), a mobile switching center and a device that undertakes a base station function in device-to-device (D2D), vehicle-to-everything (V2X), or machine-to-machine (M2M) communication; or a base station device in a 5G network or a network device in a future evolved public land mobile network (PLMN). Alternatively, the network device may be a wearable device, a vehicle-mounted device, or the like; or may include a central unit (CU) and a distributed unit (DU) in a cloud access network (CloudRAN) system; or may include a network device in an NTN, that is, may be deployed on a high-altitude platform or a satellite. In the NTN, the network device may be used as a layer 1 (L1) relay, or may be used as a base station, or may be used as a DU, or may be used as an IAB node. This is not limited in embodiments of the disclosure. Certainly, the network device may alternatively be a node in a core network.

The terminal device in embodiments of the disclosure may be a device, for example, a terminal or a chip that can be used in a terminal, configured to implement a wireless communication function. The terminal may be user equipment (UE), an access terminal, a terminal unit, a terminal station, a mobile station, a remote station, a remote terminal, a mobile device, a wireless communication device, a terminal agent or a terminal apparatus in a 5G network or a future evolved PLMN, various terminals (for example, a robot or a mechanical arm equipped with a wireless transmission module) in an industrial scenario, or the like. The access terminal may be a cellular phone, a cordless phone, a session initiation protocol (SIP) phone, a wireless local loop (WLL) station, a personal digital assistant (PDA), a handheld device or a computing device having a wireless communication function, another processing device, vehicle-mounted device, or wearable device coupled to a wireless modem, a VR terminal device, an augmented reality (AR) terminal device, a wireless terminal in industrial control, a wireless terminal in self driving, an uncrewed aerial vehicle, a sensor, an enforcer, a satellite terminal, a wireless terminal in telemedicine or telehealth services (or telemedicine), a wireless terminal in a smart grid, a wireless terminal in transportation safety, a wireless terminal in a smart city, a wireless terminal in a smart home, or the like. Alternatively, the terminal may be a terminal (for example, an internet of vehicles device) in vehicle-to-everything (V2X), a terminal in device-to-device communication, a terminal in machine-to-machine (M2M) communication, or the like.

Optionally, in embodiments of the disclosure, the network device or the terminal device may be deployed on the land, including an indoor device, an outdoor device, a handheld device, or a vehicle-mounted device; may be deployed on the water surface; or may be deployed on an airplane, a balloon, and a satellite in the air. Disclosure scenarios of the network device and the terminal device are not limited in embodiments of the disclosure.

A specific structure of an execution body of the method provided in embodiments of the disclosure is not particularly limited in embodiments of the disclosure, provided that a program that records code of the method provided in embodiments of the disclosure can be run to perform communication according to the method provided in embodiments of the disclosure. For example, the execution body of the channel state information processing method provided in embodiments of the disclosure may be a first communication apparatus or a second communication apparatus, or a functional module that is in the network device or the terminal device and that can invoke and execute the program.

In other words, a related function of the first communication apparatus or the second communication apparatus in embodiments of the disclosure may be implemented by one device, or may be jointly implemented by a plurality of devices, or may be implemented by one or more functional modules in one device. This is not specifically limited in embodiments of the disclosure. It may be understood that the foregoing function may be a network element in a hardware device, or a software function running on special-purpose hardware, or a combination of hardware and software, or a virtualization function instantiated on a platform (for example, a cloud platform).

For example, the related function of the first communication apparatus or the second communication apparatus in embodiments of the disclosure may be implemented through a communication apparatus 800 in FIG. 8. FIG. 8 is a schematic diagram of a structure of a communication apparatus 800 according to an embodiment of the disclosure. The communication apparatus 800 may include one or more processors 801, a communication line 802, and at least one communication interface (where, in FIG. 8, only an example in which the communication interface 804 and one processor 801 are included is used for description), and optionally, may further include a memory 803.

The processor 801 may be a central processing unit (CPU), a microprocessor, an application-specific integrated circuit (ASIC), or one or more integrated circuits configured to control program execution in the solutions of the disclosure.

The communication line 802 may include a path for connecting different components.

For example, the communication line 802 may be a bus, for example, an address bus, a data bus, or a control bus.

The communication interface 804 may be a transceiver module, and may be configured to communicate with another device or a communication network. For example, the transceiver module may be an apparatus such as a transceiver or a transceiver machine. Optionally, the communication interface 804 may alternatively be a transceiver circuit located in the processor 801, and is configured to implement signal input and signal output of the processor.

The memory 803 may be an apparatus having a storage function. For example, the memory may be a read-only memory (ROM), another type of static storage device capable of storing static information and instructions, a random access memory (RAM), or another type of dynamic storage device capable of storing information and instructions, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, and the like), a magnetic disk storage medium, another magnetic storage device, or any other medium capable of carrying or storing expected program code in a form of instructions or data structures and capable of being accessed by a computer, but is not limited thereto. The memory may exist independently, and is coupled to the processor through the communication line 802. Alternatively, the memory and the processor may be integrated.

The memory 803 is configured to store computer-executable instructions for executing the solutions of the disclosure, and the processor 801 controls execution of the computer-executable instructions. The processor 801 is configured to execute the computer-executable instructions stored in the memory 803, to implement the channel state information processing method provided in embodiments of the disclosure.

Alternatively, in embodiments of the disclosure, the processor 801 may perform processing-related functions in the channel state information processing method provided in the following embodiments of the disclosure, and the communication interface 804 is responsible for communicating with another device or a communication network. This is not specifically limited in embodiments of the disclosure.

The computer-executable instruction in embodiments of the disclosure may also be referred to as disclosure program code. This is not specifically limited in embodiments of the disclosure.

During specific implementation, in an embodiment, the processor 801 may include one or more CPUs, for example, a CPU 0 and a CPU 1 in FIG. 8.

During specific implementation, in an embodiment, the communication apparatus 800 may include a plurality of processors, for example, the processor 801 and a processor 808 in FIG. 8. Each of the processors may be a single-core (single-CPU) processor, or may be a multi-core (multi-CPU) processor. The processor herein may be one or more devices, circuits, and/or processing cores configured to process data (for example, computer program instructions).

During specific implementation, in an embodiment, the communication apparatus 800 may further include an output device 805 and an input device 806. The output device 805 communicates with the processor 801, and may display information in a plurality of manners.

The foregoing describes the communication system provided in the disclosure. The following describes, with reference to the accompanying drawings, the channel state information processing method provided in embodiments of the disclosure.

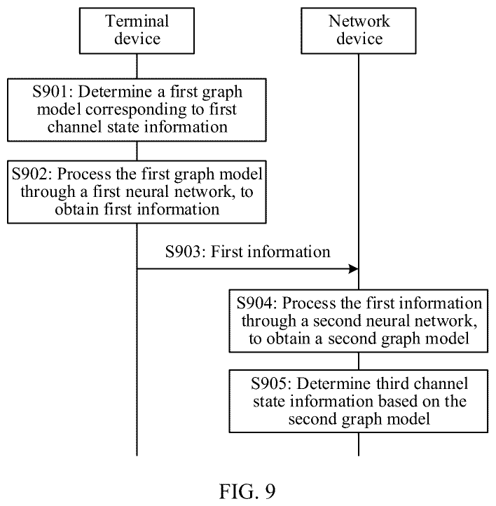

Refer to FIG. 9. FIG. 9 is a schematic interaction diagram of a channel state information processing method according to an embodiment of the disclosure. The channel state information processing method is applicable to the foregoing communication system, and may be performed by the network device or the terminal device in the foregoing communication system. The channel state information processing method can ensure validity of CSI and improve communication performance. The method may include S901 to S905, which are described in sequence below.

S901: The terminal device determines a first graph model corresponding to first channel state information.

The following separately describes the first channel state information and the first graph model.

1. The first channel state information is described as follows:

The first channel state information may include channel state information between the network device and the terminal device. Specifically, the first channel state information indicates the CSI between the network device and the terminal device. The first channel state information may include delay-angle domain channel state information between a transmit antenna of the network device and a receive antenna of the terminal device. The delay-angle domain channel state information may include channel state information between Nᵣ receiving angles and Nₜ transmitting angles, Nᵣ and Nₜ are both positive integers, and at least one of R and T is greater than 1. In some cases, Nᵣ may be denoted as R, and Nₜ may be denoted as T. In addition, the delay-angle domain channel state information may be represented using a matrix, in other words, the delay-angle domain channel state information may be a delay-angle domain channel matrix.

In the embodiment of the disclosure, unless otherwise specified, Nᵣ may represent a quantity of receive antennas of the terminal device, and Nₜ may represent a quantity of transmit antennas of the network device. This is uniformly described herein, and details are not described below again.

Before S901, the terminal device may determine the first channel state information. The following describes in detail the first channel state information and an implementation in which “the terminal device determines the first channel state information”.

Optionally, that the terminal device determines the first channel state information may include: The terminal device determines the first channel state information based on space-frequency domain channel state information between the transmit antenna of the network device and the receive antenna of the terminal device. The space-frequency domain channel state information may be represented using a matrix, in other words, the space-frequency domain channel state information may be a space-frequency domain channel matrix.

For example, the terminal device may receive a reference signal sent by the network device, and perform CSI estimation based on the reference signal, to obtain the space-frequency domain channel matrix (denoted as \tilde{H}) between the transmit antenna of the network device and the receive antenna of the terminal device. The reference signal sent by the network device may be a channel state information-reference signal (channel state information-reference signal, CSI-RS). Then, the terminal device may perform discrete Fourier transform (DFT) on \tilde{H} to obtain the delay-angle domain channel matrix (denoted as H̅). H̅ is the delay-angle domain channel state information, that is, the first channel state information.

It is assumed that the network device includes Nₜ transmit antennas, and the terminal device includes Nᵣ receive antennas. In this case, the space-frequency domain channel matrix includes channel state information between the Nₜ transmit antennas and the Nᵣ receive antennas, and after the discrete Fourier transform is performed on space domain of the space-frequency domain channel matrix, channel state information between the Nₜ transmitting angles and the Nᵣ receiving angles in angle domain may be correspondingly obtained. Based on this, the foregoing process of determining H̅ may include the following several implementations (manner 1 to manner 3).

Manner 1: A corresponding delay-angle domain channel matrix (denoted as H̅i) is determined for each receiving angle, i is a positive integer, and i≤Nᵣ. H̅ includes Nᵣ H̅i.

For example, the terminal device may estimate channels between an i^{th} receive antenna in the Nᵣ receive antennas and the Nₜ transmit antennas based on the reference signal, to obtain a space-frequency domain channel matrix (denoted as \tilde{H}i) between the i^{th} receive antenna and the Nₜ transmit antennas. H̅i∈ [symbol] ^{Ñ}^{_{c}}^{×N}^{ₜ},Ñ_{c} is a quantity of subcarriers, and [symbol] represents a complex number domain. Then, the terminal device may perform two-dimensional DFT on \tilde{H}i, to obtain a delay-angle domain channel matrix (that is, H̅i) corresponding to an i^{th} receiving angle. It can be learned that, in the manner 1, Nᵣ H̅i are obtained, each H̅i corresponds to one receiving angle, and all H̅i are a delay-angle domain channel matrix (that is, H̅). Unless otherwise specified, Ñ_{c} may indicate the quantity of subcarriers. This is uniformly described herein, and details are not described below again.

In the manner 1, H̅i may represent channel state information between one receiving angle and the Nₜ transmitting angles, and all H̅i may represent the channel state information between the Nᵣ receiving angles and the Nₜ transmitting angles, in other words, H̅ may include the channel state information between the Nᵣ receiving angles and the Nₜ transmitting angles.

Manner 2: A corresponding delay-angle domain channel matrix (denoted as H̅j) is determined for each transmitting angle, j is a positive integer, and j≤Nₜ. H includes Nₜ H̅j.

For example, the terminal device may estimate channels between a j^{th} transmit antenna in the Nₜ transmit antennas and the Nᵣ receive antennas based on the reference signal, to obtain a space-frequency domain channel matrix (denoted as \tilde{H}j) between the j^{th} transmit antenna and the Nᵣ receive antennas. \tilde{H}j∈ [symbol] ^{Ñ}^{_{c}}^{×N}^{ᵣ}. Then, the terminal device may perform two-dimensional DFT on \tilde{H}j, to obtain a delay-angle domain channel matrix (that is, H̅j) corresponding to a j^{th} transmitting angle. It can be learned that, in the manner 2, Nₜ H̅j are obtained, each H̅j corresponds to one transmit antenna, and all H̅j are a delay-angle domain channel matrix (that is, H̅).

In the manner 2, H̅j may represent channel state information between one transmitting angle and the Nᵣ receiving angles, and all H̅j may represent the channel state information between the Nᵣ receiving angles and the Nₜ transmitting angles, in other words, H̅ may include the channel state information between the Nᵣ receiving angles and the Nₜ transmitting angles.

Manner 3: A corresponding delay-angle domain channel matrix (denoted as H̅z) is determined for all the transmitting angles and all the receiving angles. H̅z is H̅.

For example, the terminal device may estimate channels between the Nᵣ receive antennas and the Nₜ transmit antennas based on the reference signal, to obtain a space-frequency domain channel matrix (denoted as \tilde{H}z) between the Nᵣ receive antennas and the Nₜ transmit antennas. \tilde{H}z∈ [symbol] ^{Ñ}^{_{c}}^{×N}^{ₜ}^{×N}^{ᵣ}. Then, the terminal device may perform three-dimensional DFT on \tilde{H}z to obtain a delay-angle domain channel matrix (that is, H̅z).

In the manner 3, H̅z may represent the channel state information between the Nᵣ receiving angles and the Nₜ transmitting angles, that is, H̅ may include the channel state information between the Nᵣ receiving angles and the Nₜ transmitting angles.

2. The first graph model is described as follows:

The first graph model may include a plurality of nodes, a feature of one node may include channel state information between a j^{th} transmitting angle in Nₜ transmitting angles and an i^{th} receiving angle in Nᵣ receiving angles, i and j are both positive integers, i≤Nᵣ, and j≤Nₜ. In other words, features of the plurality of nodes may include channel state information between the Nₜ transmitting angles and Nᵣ receiving angles. The first graph model may further include at least one edge. Each edge may be coupled to two nodes, and each edge may indicate that the two nodes coupled to the edge correspond to two adjacent receiving angles or two adjacent transmitting angles.

The following describes in detail the first graph model and an implementation of S901.

In some possible embodiments, S901 in which the terminal device determines the first graph model corresponding to the first channel state information may include: the terminal device determines, based on transmit and receive antenna configuration information, the first graph model corresponding to the first channel state information.

The transmit and receive antenna configuration information may include receive antenna configuration information of the terminal device and transmit antenna configuration information of the network device. Optionally, the receive antenna configuration information of the terminal device may include one or more of the following: a quantity of receive antennas of the terminal device, a type of a receive antenna panel, and an arrangement manner of receive antenna units. The transmit antenna configuration information of the network device may include one or more of the following: a quantity of transmit antennas of the network device, a type of a transmit antenna panel, and an arrangement manner of transmit antenna units. The terminal device may determine one or more of the following information based on the transmit and receive antenna configuration information: Nₜ transmit antennas of the network device form an antenna array of Nₜ₁ columns and Nₜ₂ rows, Nᵣ receive antennas of the terminal device form an antenna array of Nᵣ₁ columns and Nᵣ₂ rows, and Nₜ=Nₜ₁×Nₜ₂.

During actual disclosure, the transmit and receive antenna configuration information may be predefined in a protocol, or may be indicated by the network device to the terminal device through signaling. For example, before S902, the network device may further send the transmit and receive antenna configuration information to the terminal device, and correspondingly, the terminal device receives the transmit and receive antenna configuration information from the network device. A specific implementation in which the terminal device obtains the transmit and receive antenna configuration information is not limited in the embodiment of the disclosure.

Specifically, that the terminal device determines, based on the transmit and receive antenna configuration information, the first graph model corresponding to the first channel state information may include the following several implementations (manner 4 to manner 6).

Manner 4: A corresponding first subgraph model is determined for each receiving angle, and all first subgraph models are the first graph model.

Specifically, an example in which a first subgraph model corresponding to the i^{th} receiving angle is determined for the i^{th} receiving angle in the Nᵣ receiving angles is used. The terminal device may obtain, in the foregoing manner 1, H̅i corresponding to the i^{th} receiving angle. Then, the terminal device determines, based on the transmit and receive antenna configuration information, the first subgraph model corresponding to H̅i.

For example, it is assumed that the terminal device determines, based on the transmit and receive antenna configuration information, that the Nₜ transmit antennas of the network device form an antenna array of N₁ columns and N₂ rows. In this case, the terminal device may determine that H̅i∈ [symbol] ^{Ñ}^{_{c}}^{×N}^{₁}^{×N}^{₂}. In other words, H̅i may include N₁×N₂ transmitting angles in angle domain. The j^{th} angle in the N₁×N₂ transmitting angles may include a vector (denoted as Xj, where j is a positive integer, and j≤Nₜ) in a time domain dimension, and Xj includes Ñ_{c} elements, that is, a length of Xj is Ñ_{c}. Xj may represent the channel state information between the j^{th} transmitting angle and the i^{th} receiving angle, and all Xj may represent channel state information between the Nₜ transmitting angles and the i^{th} receiving angle.

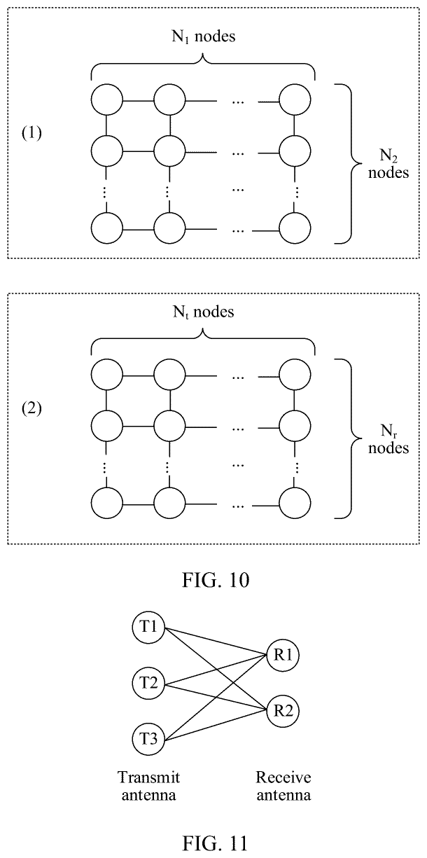

Refer to (1) in FIG. 10. FIG. 10 is a schematic diagram of a first subgraph model according to an embodiment of the disclosure. The terminal device may determine the N₁×N₂ angles as nodes in the first subgraph model, that is, the first subgraph model includes N₁×N₂ nodes. A feature of each node is a vector (namely, Xj) included in the time domain dimension in a transmitting angle corresponding to the node. The terminal device may further determine an edge in the first subgraph model based on H̅i. For example, the terminal device may determine, based on transmitting angles corresponding to the N₁×N₂ angles included in angle domain by H̅i, that an edge exists between two nodes that are in the first subgraph model and that correspond to adjacent transmitting angles. In other words, each edge may indicate that the two nodes coupled to the edge correspond to two adjacent transmitting angles.

To facilitate calculation by a device and reduce a data processing amount of the device, optionally, the terminal device may determine, based on an adjacency relationship between the N₁×N₂ angles included in angle domain by H̅i, that an edge exists between adjacent nodes in the first subgraph model and that no edge exists between non-adjacent nodes. In other words, each edge may indicate that the two nodes coupled to the edge are adjacent in the first subgraph model. Because a correlation between non-adjacent angles is usually small, an implementation in which the edge exists between the adjacent nodes in the first subgraph model can not only reduce the data processing amount of the device, but also ensure validity of channel state information.

Optionally, the terminal device may determine, based on transmitting angles corresponding to the N₁×N₂ angles included in angle domain by H̅i, that an edge exists between two nodes that are in the first subgraph model and that correspond to a same receiving angle.

Xj is a complex number vector of Ñ_{c} dimensions, and Xj may also be denoted as H[1:Ñ_{c},j], H[1:Ñ_{c},j] represents all elements of the j^{th} transmitting angle in the time domain dimension, and H[1:Ñ_{c},j] may be simply represented as H[:,j]. To facilitate the calculation by the device and reduce the data processing amount of the device, optionally, an imaginary part and a real part that are of H[:,j] may be concatenated into a vector of 2Ñ_{c} dimensions, that is, the imaginary part and the real part that are of H[:,j] are processed separately.

In some possible embodiments, the first subgraph model may be represented using an adjacency matrix and a node feature matrix. For example, the terminal device determines the N₁×N₂ angles as the nodes in the first subgraph model. The terminal device may represent a coupling relationship between the nodes in the first subgraph model by using an adjacency matrix A of N₁×N₂ rows and N₁×N₂ columns (A∈ [symbol] ^{(N}^{₁}^{×N}^{₂}^{)×(N}^{₁}^{×N}^{₂₎}).

$$A = [ \begin{matrix}{A}_{1 , 1} & … & {A}_{1 , {N}_{t}} \\ ⋮ & ⋱ & ⋮ \\ {A}_{{N}_{t} , 1} & … & {A}_{{N}_{t} , {N}_{t}}\end{matrix} ] ,$$

if an element in an i^{th} row and a j^{th} column that are of A (denoted as A_{i,j}) is 1, it may indicate that an edge exists between a node i and a node j, and A_{i,j}=0 may indicate that no edge exists between the node i and the node j. The terminal device may further indicate respective features of the N₁×N₂ nodes by using a node feature matrix B(B=[X1 X2 . . . Xj . . . XNₜ]).

Refer to FIG. 11. FIG. 11 is a schematic diagram of coupling between transmit and receive antennas according to an embodiment of the disclosure. Transmit antennas of the network device include T1, T2, and T3 (that is, Nₜ=3), and receive antennas of the terminal device include R1 and R2 (that is, Nᵣ=2). The following further describes the foregoing manner 4 with reference to FIG. 11.

Based on FIG. 11, the terminal device may obtain H̅i (where i=1 or 2) in the foregoing manner 1, H̅1 corresponds to R1, and H̅2 corresponds to R2. Then, for each H̅i, the terminal device may determine, based on the transmit and receive antenna configuration information (for example, FIG. 11), the first subgraph model corresponding to H̅i. For a specific implementation, refer to related descriptions in the manner 4.

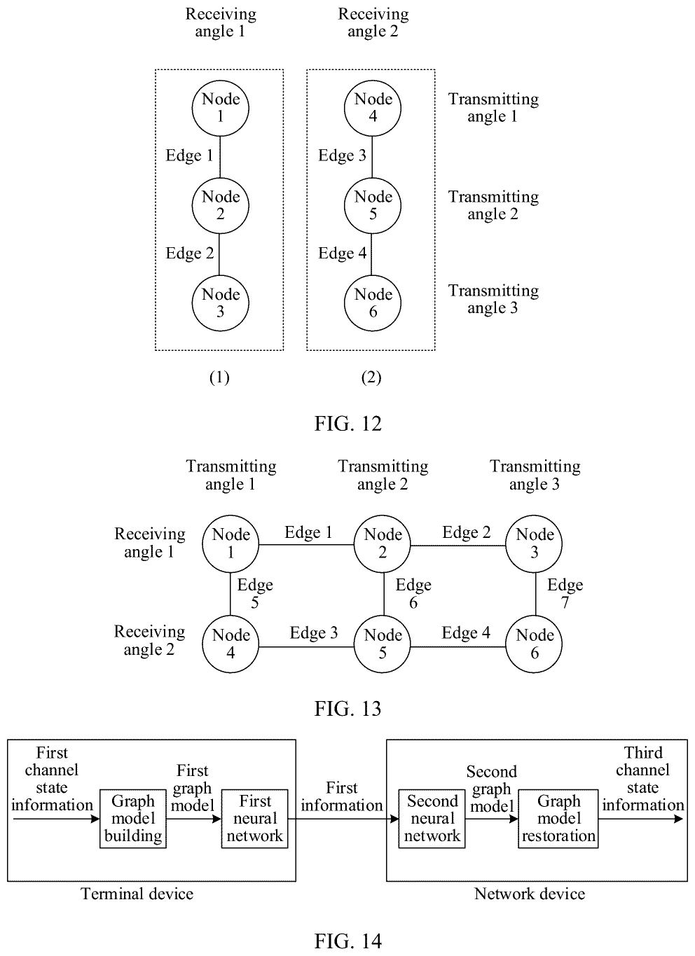

With reference to the related descriptions in the foregoing manner 4, for H̅1, the terminal device may determine a first subgraph model shown in (1) in FIG. 12, and for H̅2, the terminal device may determine a first subgraph model shown in (2) in FIG. 12.

It can be learned that the first subgraph model corresponding to H̅1 may include three nodes (including a node 1 to a node 3) and two edges (including an edge 1 and an edge 2). The node 1 to the node 3 correspond to a receiving angle 1, the node 1 further corresponds to a transmitting angle 1, the node 2 further corresponds to a transmitting angle 2, and the node 3 further corresponds to a transmitting angle 3. The edge 1 is coupled to the node 1 and the node 2, and the edge 2 is coupled to the node 2 and the node 3. The first subgraph model corresponding to H̅2 is similar to the first subgraph model corresponding to H̅1. Details of (2) in FIG. 12 are not described herein again.

The first subgraph model corresponding to H̅1 may be represented using an adjacency matrix A and a node feature matrix B below:

$$A = [ \begin{matrix}1 & 1 & 0 \\ 1 & 1 & 1 \\ 0 & 1 & 1\end{matrix} ] ; and B = [ \begin{matrix}X 1 & X 2 & X 3\end{matrix} ] .$$

Manner 5: A corresponding second subgraph model is determined for each transmitting angle, and all second subgraph models are the first graph model.

Specifically, an example in which a second subgraph model corresponding to the j^{th} transmitting angle is determined for the j^{th} transmitting angle in the Nₜ transmitting angles is used. The terminal device may obtain, in the foregoing manner 2, H̅j corresponding to the j^{th} transmitting angle. Then, the terminal device determines, based on the transmit and receive antenna configuration information, the second subgraph model corresponding to H̅j.

For example, it is assumed that the terminal device determines, based on the transmit and receive antenna configuration information, that Nᵣ receive antennas of the network device form an antenna array of N₁ columns and N₂ rows. In this case, the terminal device may determine that H̅j∈ [symbol] ^{Ñ}^{_{c}}^{×N}^{₁}^{×N}^{₂}. In other words, H̅j may include N₁×N₂ angles in angle domain. The i^{th} angle in the N₁×N₂ angles may include a vector (denoted as Ui, where i is a positive integer, and i≤Nᵣ) in a time domain dimension, and Ui includes Ñ_{c} elements, that is, a length of Ui is Ñ_{c}. Ui may represent the channel state information between the i^{th} receiving angle and the j^{th} transmitting angle, and all Ui may represent channel state information between the Nᵣ receiving angles and the j^{th} transmitting angle.

Refer to (1) in FIG. 10 again. The terminal device may determine the N₁×N₂ angles as nodes in the second subgraph model, that is, the second subgraph model includes N₁×N₂ nodes. A feature of each node is a vector (namely, Ui) included in the time domain dimension in a receiving angle corresponding to the node. The terminal device may further determine an edge in the second subgraph model based on H̅j. For example, the terminal device may determine, based on receiving angles corresponding to the N₁×N₂ angles included in angle domain by H̅j, that an edge exists between two nodes that are in the second subgraph model and that correspond to adjacent receiving angles. In other words, each edge may indicate that the two nodes coupled to the edge correspond to two adjacent receiving angles.

To facilitate calculation by a device and reduce a data processing amount of the device, optionally, the terminal device may determine, based on an adjacency relationship between the N₁×N₂ angles included in angle domain by H̅j, that an edge exists between adjacent nodes in the second subgraph model and that no edge exists between non-adjacent nodes. In other words, each edge may indicate that the two nodes coupled to the edge are adjacent in the second subgraph model. Because a correlation between non-adjacent angles is usually small, an implementation in which the edge exists between the adjacent nodes in the second subgraph model can not only reduce the data processing amount of the device, but also ensure validity of channel state information.

Optionally, the terminal device may determine, based on receiving angles corresponding to the N₁×N₂ angles included in angle domain by H̅j, that an edge exists between two nodes that are in the second subgraph model and that correspond to a same transmitting angle.

Ui is a complex number vector of Ñ_{c} dimensions, and Ui may also be denoted as H[1:Ñ_{c},i], H[1:Ñ_{c},i] represents all elements of the i^{th} receiving angle in the time domain dimension, and H[1:Ñ_{c},i] may be simply represented as H[:,i]. To facilitate the calculation by the device and reduce the data processing amount of the device, optionally, an imaginary part and a real part that are of H[:,i] may be concatenated into a vector of 2Ñ_{c} dimensions, that is, the imaginary part and the real part that are of H[:,i] are processed separately.

In some possible embodiments, the second subgraph model may be represented using an adjacency matrix and a node feature matrix. For example, the terminal device determines the N₁×N₂ angles as the nodes in the second subgraph model. The terminal device may represent a coupling relationship between the nodes in the second subgraph model by using an adjacency matrix A of N₁×N₂ rows and N₁×N₂ columns (A∈ [symbol] ^{(N}^{₁}^{×N}^{₂}^{)×(N}^{₁}^{×N}^{₂}⁾).

$$A = [ \begin{matrix}{A}_{1 , 1} & … & {A}_{1 , {N}_{r}} \\ ⋮ & ⋱ & ⋮ \\ {A}_{{N}_{r} , 1} & … & {A}_{{N}_{r} , {N}_{r}}\end{matrix} ] ,$$

if an element in an i^{th} row and a j^{th} column that are of A (denoted as A_{i,j}) is 1, it may indicate that an edge exists between a node i and a node j, and A_{i,j}=0 may indicate that no edge exists between the node i and the node j. The terminal device may further indicate respective features of the N₁×N₂ nodes by using a node feature matrix B (B=[U1 U2 . . . Ui . . . UNᵣ]).

For detailed descriptions of an implementation process of the manner 5, refer to related descriptions in the foregoing manner 4 with reference to FIG. 11 and FIG. 12. Details are not described herein again.

Manner 6: A corresponding first graph model is determined for all the transmitting angles and all the receiving angles.

Specifically, the terminal device may obtain H̅z in the foregoing manner 3, and then determine, based on the transmit and receive antenna configuration information, the first graph model corresponding to H̅z.

For example, it is assumed that the terminal device determines, based on the transmit and receive antenna configuration information, that the network device includes the Nₜ transmit antennas and the terminal device includes the Nᵣ receive antennas. In this case, the terminal device may determine that H̅z∈ [symbol] ^{Ñ}^{_{c}}^{×N}^{ₜ}^{×N}^{ᵣ}. In other words, H̅z may include Nₜ×Nᵣ angle pairs in angle domain. If the Nₜ×Nᵣ angle pairs are represented using a matrix, to be specific, the Nₜ×Nᵣ angle pairs include angle pairs in Nᵣ rows and Nₜ columns, an angle pair in an i^{th} row and a j^{th} column that are in the Nₜ×Nᵣ angle pairs (denoted as G(i,j)) may include a vector in a time domain dimension (denoted as V(i,j), where both i and j are positive integers, i≤Nᵣ, and j≤Nₜ), and V(i,j) includes Ñ_{c} elements, that is, a length of V(i,j) is Ñ_{c}. G(i,j) corresponds to the j^{th} transmitting angle, and corresponds to the i^{th} receiving angle. V(i,j) may represent the channel state information between the j^{th} transmitting angle and the i^{th} receiving angle, and all V(i,j) may represent the channel state information between the Nₜ transmitting angles and the Nᵣ receiving angles.

Refer to (2) in FIG. 10. The terminal device may determine the Nₜ×Nᵣ angle pairs as nodes in the first graph model, that is, the first graph model includes Nₜ×Nᵣ nodes. A feature of each node is a vector (namely, V(i,j)) included in the time domain dimension by an angle pair corresponding to the node. The terminal device may further determine an edge in the first subgraph model based on H̅z. For example, the terminal device may determine, based on a transmitting angle and a receiving angle that correspond to an angle pair included in angle domain by H̅z, that an edge exists between two nodes that are in the first graph model and that correspond to adjacent receiving angles or adjacent transmitting angles. In other words, each edge may indicate that the two nodes coupled to the edge correspond to two adjacent receiving angles or two adjacent transmitting angles.

To facilitate calculation by a device and reduce a data processing amount of the device, optionally, the terminal device may determine, based on an adjacency relationship between angles included in angle domain by H̅z, that an edge exists between adjacent nodes in the first graph model and that no edge exists between non-adjacent nodes. In other words, each edge may indicate that the two nodes coupled to the edge are adjacent in the first graph model. Because a correlation between non-adjacent angles is usually small, an implementation in which the edge exists between the adjacent nodes in the first graph model can not only reduce the data processing amount of the device, but also ensure validity of channel state information.

Optionally, the terminal device may determine, based on the transmitting angle and the receiving angle that correspond to the angle pair included in angle domain by H̅z, that an edge exists between two nodes that are in the first graph model and that correspond to a same transmitting angle or a same receiving angle.

V(i,j) is a complex number vector of Ñ_{c} dimensions, V(i,j) may also be denoted as H[1:Ñ_{c},i,j], H[1:N̅_{c},i,j] represents all elements of an angle pair in the time domain dimension, and H[1:N̅_{c},i,j] may be simply represented as H[:,i,j]. To facilitate the calculation by the device and reduce the data processing amount of the device, optionally, an imaginary part and a real part that are of H[:,i,j] may be concatenated into a vector of 2Ñ_{c} dimensions, that is, the imaginary part and the real part that are of H[:,i,j] are processed separately.

In some possible embodiments, the first graph model may be represented using an adjacency matrix and a node feature matrix. For example, the terminal device determines the Nₜ×Nᵣ angle pairs as the nodes in the first graph model. The terminal device may represent a coupling relationship between the nodes in the first graph model by using an adjacency matrix A of Nₜ×Nᵣ rows and Nₜ×Nᵣ columns (A∈ [symbol] ^{(N}^{ₜ}^{×N}^{ᵣ}^{)×(N}^{ₜ}^{×N}^{ᵣ}⁾).

$$A = [ \begin{matrix}{A}_{1 , 1} & … & {A}_{1 , {N}_{t} \times {N}_{r}} \\ ⋮ & ⋱ & ⋮ \\ {A}_{{N}_{t} ,} \times {N}_{r} , 1 & … & {A}_{{N}_{t} \times {N}_{r} , {N}_{t} \times {N}_{r}}\end{matrix} ] ,$$

if an element in an i^{th} row and a j^{th} column that are of A (denoted as A_{i,j}) is 1, it may indicate that an edge exists between a node i and a node j, and A_{i,j}=0 may indicate that no edge exists between the node i and the node j. The terminal device may further indicate respective features of the nodes by using a node feature matrix

$$( B = [ \begin{matrix}V ( 1 , 1 ) & … & V ( 1 , {N}_{t} \times {N}_{r} ) \\ ⋮ & ⋱ & ⋮ \\ V ( {N}_{t} \times {N}_{r} , 1 & … & V ( {N}_{t} \times {N}_{r} , {N}_{t} \times {N}_{r} )\end{matrix} ] ) .$$

An element in an i^{th} row and a j^{th} column that are of B is V(i,j).

The following further describes the foregoing manner 6 with reference to FIG. 11.

Based on FIG. 11, the terminal device may obtain H̅z in the foregoing manner 3, and then determine, based on the transmit and receive antenna configuration information (for example, FIG. 11), the first graph model corresponding to H̅z. For a specific implementation, refer to related descriptions in the foregoing manner 6.

With reference to the related descriptions in the foregoing manner 6, for H̅z, the terminal device may determine a first graph model shown in FIG. 13. It can be learned that the first graph model corresponding to H̅z may include six nodes (including a node 1 to a node 6) and seven edges (including an edge 1 to an edge 7). For a transmitting angle and a receiving angle that correspond to each node, and a coupling relationship between the nodes, refer to FIG. 13. Details are not described herein again. To reduce the data processing amount of the device, no edge exists between two non-adjacent nodes in FIG. 13.

The first graph model corresponding to H̅z may be represented using an adjacency matrix A and a node feature matrix B below:

$$A = [ \begin{matrix}1 & 1 & 0 & 1 & 0 & 0 \\ 1 & 1 & 1 & 0 & 1 & 0 \\ 0 & 1 & 1 & 0 & 0 & 1 \\ 1 & 0 & 0 & 1 & 1 & 0 \\ 0 & 1 & 0 & 1 & 1 & 1 \\ 0 & 0 & 1 & 0 & 1 & 1\end{matrix} ] ; and B = [ \begin{matrix}V ( 1 , 1 ) & V ( 1 , 2 ) & V ( 1 , 3 ) \\ V ( 2 , 1 ) & V ( 2 , 2 ) & V ( 2 , 3 ) \\ V ( 3 , 1 ) & V ( 3 , 2 ) & V ( 3 , 3 )\end{matrix} ] .$$

In the foregoing manner 4 to manner 6, channel state information included in the feature of each node may include Ñ_{c} elements in time domain. In some possible embodiments, the channel state information included in the feature of each node may include C elements in time domain, and C is less than or equal to a quantity of subcarriers, that is, C≤Ñ_{c}. In other words, in the embodiment of the disclosure, all elements included in the channel state information included in the feature of each node in time domain may be reserved, or a part may be discarded and a remaining part is used as the feature of each node.

For example, in the foregoing manner 4, for the obtained H̅i∈ [symbol] ^{Ñ}^{_{c}}^{×N}^{₁}^{×N}^{₂}, H̅i has Ñ_{c} elements in time domain, and first N_{c} elements of H̅i in time domain may be reserved, to obtain truncated H̅i (which may be denoted as Hi, where Hi∈ [symbol] ^{N}^{_{c}}^{×N}^{ₜ}). Then, the terminal device may determine, based on the transmit and receive antenna configuration information, a first subgraph model corresponding to Hi. For a specific manner, refer to the foregoing manner 4. Details are not described herein again. This manner may be denoted as truncation of a delay-angle domain channel matrix in the time domain dimension. Therefore, N̅_{c} may further represent a length of a time domain dimension before the truncation of the delay-angle domain channel matrix in the time domain dimension, and N_{c} may represent a length of a time domain dimension after the truncation of the delay-angle domain channel matrix in the time domain dimension. This is uniformly described herein, and details are not described below again. In this case, if an imaginary part and a real part that are of H[:,i,j] are processed separately, a quantity of dimensions of Xj in the foregoing manner 4 is 2N_{c}.

Because channel state information is sparse in time domain, a quantity of elements included in the channel state information included in the feature of each node in time domain is appropriately reduced, and accuracy of the CSI is not affected. In other words, when C is less than the quantity of subcarriers, a data processing amount of a communication apparatus can be reduced without affecting accurate restoration of the first channel state information by a second communication apparatus, and a processing rate of the communication apparatus can be increased.

S902: The terminal device processes the first graph model through a first neural network, to obtain first information.

The first information is used by the network device to restore the first channel state information. For example, the first information may include first channel state information processed by the first neural network. In this way, the network device may restore the first channel state information based on the first information.

In a process of processing the first graph model, the first neural network may compress feature information included in the first graph model. In a process in which the first neural network compresses the feature information included in the first graph model, important feature information may be reserved, and unimportant feature information may be discarded (or omitted). Because the unimportant feature information in the feature information included in the first graph model may be discarded, to improve accuracy of restoring the first channel state information by the network device based on the first information, in some possible embodiments, the first information may include auxiliary information, the auxiliary information may be used to determine a second graph model, and the second graph model may be used to restore the first channel state information. The first information may include second channel state information and the auxiliary information. That the auxiliary information is used to determine the second graph model means that the second graph model may be restored by using the auxiliary information together with the second channel state information. In this way, the network device may determine the second graph model by using the auxiliary information, and restore the first channel state information based on the second graph model. In other words, the auxiliary information may help the second communication apparatus restore the first channel state information, and improve accuracy of the first channel state information restored by the second communication apparatus.

Optionally, the auxiliary information may include index information of a part of nodes of the first graph model. In other words, the auxiliary information may indicate some feature information (for example, discarded or reduced feature information) in the first graph model. In this way, the terminal device may indicate, by using the auxiliary information, indexes of a part of nodes that are in the first graph model and that are discarded due to compression, to help the network device restore the first channel state information, and improve the accuracy of the first channel state information restored by the network device.

For example, the auxiliary information may include index information of a discarded node in the first graph model, or the auxiliary information may include index information of a reserved node in the first graph model. In this way, this may further help the network device restore the first channel state information, and improve the accuracy of the first channel state information restored by the network device.

Further, the auxiliary information may further include an average value of features of the part of nodes. For example, the auxiliary information may further include an average value of features of nodes discarded in a processing process of the first graph model. In this way, this may further help the network device restore the first channel state information, and improve the accuracy of the first channel state information restored by the network device.

The index information of the node may also be referred to as a sequence number of the node, an identifier of the node, location information of the node, or the like. This is not limited herein.

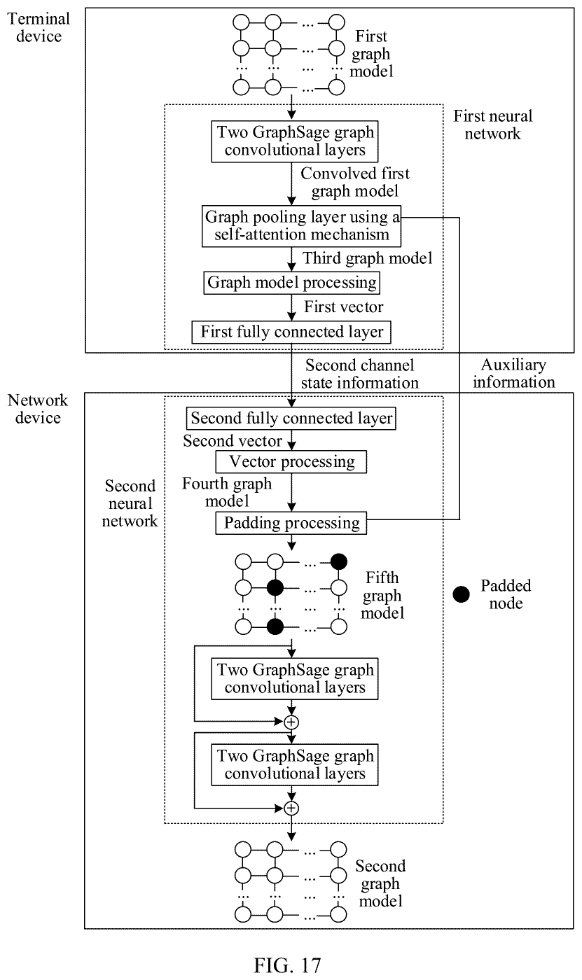

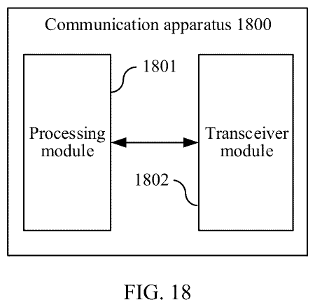

For a specific implementation of the foregoing auxiliary information, refer to related descriptions of an example shown in FIG. 17 below. Details are not described herein again.

The following describes an implementation of S902 in which the first graph model is processed through the first neural network to obtain the first information.

In some possible embodiments, as shown in FIG. 14, the first neural network may be configured to determine the first information based on the first graph model. The first information may include the second channel state information and the foregoing auxiliary information, and the second channel state information may include the processed first channel state information.

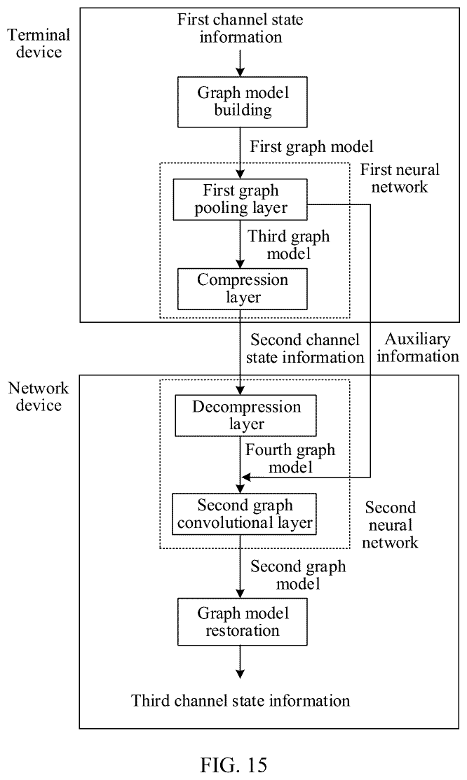

For example, refer to FIG. 15. FIG. 15 is a schematic diagram 2 of a structure of a neural network according to an embodiment of the disclosure. The first neural network may include a first graph pooling layer and a compression layer.

The first graph pooling layer may be configured to determine a third graph model and the auxiliary information based on the first graph model, and the compression layer may be configured to determine the second channel state information based on the third graph model.

Inputs of the first pooling layer may be graph models of different structures and/or different scales. To be specific, for terminal devices and network devices (which are collectively referred to as two ends for receiving and transmitting CSI below) with different antenna configurations, the terminal devices may determine first graph models corresponding to first channel state information, and input the first graph models into a same first neural network. Specifically, the first graph pooling layer may reserve a fixed quantity of important nodes in the first graph model, and discard unimportant nodes in the first graph model, so that a structure (or referred to as a size or a scale) of the determined third graph model is fixed, that is, the third graph model is irrelevant to a structure and/or a scale of the input first graph model. In this way, the first graph models of different structures and/or different scales may be processed through the same first graph pooling layer and the same compression layer. In addition, because different antenna configurations of the two ends for receiving and transmitting the CSI cause structures of the first graph model to be different, for the two ends that receive and transmit the CSI and that have the different antenna configurations, the first channel state information may be processed through the same first graph pooling layer and the same compression layer. In other words, design and training that are of the first neural network do not depend on the antenna configurations of the two ends for receiving and transmitting the CSI. In this way, when the antenna configurations of the two ends for receiving and transmitting the CSI change, the neural network may be avoided from being redesigned and trained, and the neural network is applicable to a dynamic MIMO system and MIMO systems with different antenna configurations.

Optionally, the first graph pooling layer may be a graph pooling layer using a self-attention mechanism. Because a small quantity of parameters of the graph pooling layer using the self-attention mechanism need to be trained, and feature information of a node in the first graph model and topology structure information of a graph can be fully extracted, that “the first graph pooling layer is the graph pooling layer using the self-attention mechanism” can improve training efficiency and a processing capability that are of the neural network.

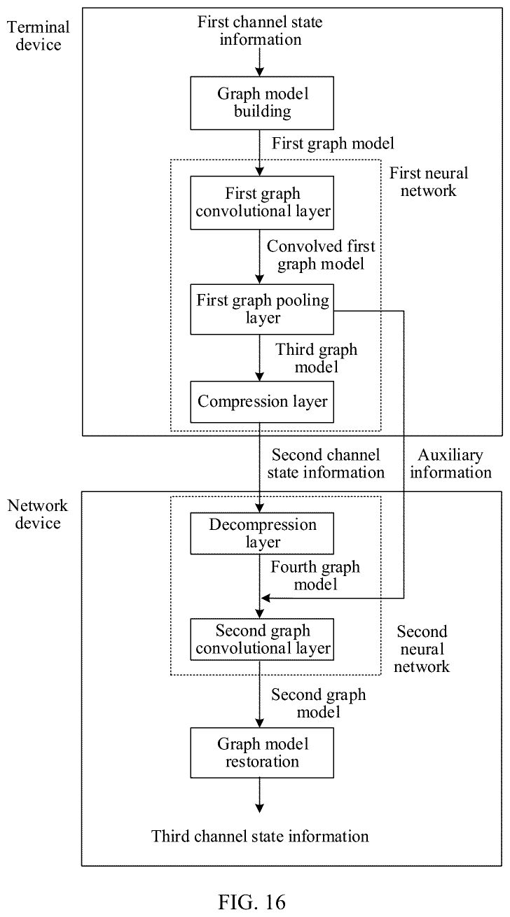

In some other possible embodiments, refer to FIG. 16. FIG. 16 is a schematic diagram 3 of a structure of a neural network according to an embodiment of the disclosure. The first neural network may include a first graph convolutional layer, a first graph pooling layer, and a compression layer.

The first graph convolutional layer is configured to determine a convolved first graph model based on the first graph model, the first graph pooling layer is configured to determine a third graph model and the auxiliary information based on the convolved first graph model, and the compression layer is configured to determine the second channel state information based on the third graph model.

It can be learned that a difference between the first neural network shown in FIG. 15 and the first neural network shown in FIG. 16 lies in whether the first graph convolutional layer is included. Therefore, for descriptions of the first graph pooling layer and the compression layer, refer to related descriptions of the first neural network shown in FIG. 15. Details are not described herein again. Optionally, the first graph convolutional layer may include a plurality of graph convolutional layers. The first graph convolutional layer may be any type of graph convolutional layer such as a graph convolution network (GCN) graph convolutional layer or a graph sample and aggregate (GraphSage) graph convolutional layer.

The first graph convolutional layer may extract and reserve a feature of an important node in the first graph model, and omit a feature of an unimportant node. Therefore, in the first neural network shown in FIG. 16, the first graph convolutional layer can implement preliminary channel information compression.

For a same reason as the first neural network shown in FIG. 15, design and training that are of the first neural network shown in FIG. 16 do not depend on the antenna configurations of the two ends for receiving and transmitting the CSI. In this way, when the antenna configurations of the two ends for receiving and transmitting the CSI change, the neural network may be avoided from being redesigned and trained, and the neural network is applicable to a dynamic MIMO system and MIMO systems with different antenna configurations.

For example, the first neural network shown in FIG. 15 and the compression layer in the first neural network shown in FIG. 16 may compress the third graph model into data of a specific length, that is, the second channel state information. The second channel state information may include compressed first channel state information.

Optionally, the compression layer in the first neural network may be a fully coupled layer.

For a specific implementation of the first neural network, refer to related descriptions of an example shown in FIG. 17 below. Details are not described herein again.

S903: The terminal device sends the first information to the network device. Correspondingly, the network device receives the first information from the terminal device.

The first information may be carried on an uplink channel, for example, a physical uplink control channel (PUCCH), a physical uplink shared channel (PUSCH), or another physical uplink channel, for example, a physical channel that may be defined in the future and that may be used to carry the first information. This is not limited in the embodiment of the disclosure.

S904: The network device processes the first information through a second neural network, to obtain a second graph model.

Optionally, the first information may include the auxiliary information and the second channel state information. For related descriptions of the auxiliary information and the second channel state information, refer to the related descriptions in S902. Details are not described herein again.

Optionally, refer to FIG. 14. The second neural network may be configured to determine the second graph model based on the second channel state information and the auxiliary information.

For example, refer to FIG. 15 or FIG. 16. The second neural network may include a decompression layer and a second graph convolutional layer.

The decompression layer may be configured to determine a fourth graph model based on the second channel state information. For example, the decompression layer may decompress the second channel state information into data of a specific length, to determine the fourth graph model. Optionally, the decompression layer may be a fully coupled layer.

The second graph convolutional layer may be configured to determine the second graph model based on the auxiliary information and the fourth graph model. Specifically, that the second graph convolutional layer is configured to determine the second graph model based on the auxiliary information and the fourth graph model may include: The network device restores a missing node in the fourth graph model based on the auxiliary information, to obtain a fifth graph model; and then inputs the fifth graph model into the second graph convolutional layer. The second graph convolutional layer is configured to determine the second graph model based on the fifth graph model. For example, the second graph convolutional layer may be configured to perform convolution on the fifth graph model, to obtain the second graph model. It may be understood that the fifth graph model may be considered to supplement the fourth graph model in which a part of nodes are discarded.

The auxiliary information may further include the average value of the features of the nodes discarded in the processing process of the first graph model. In other words, the auxiliary information may further include an average value of discarded nodes in the first graph model. Therefore, for descriptions of the first graph model, refer to the foregoing descriptions. Details are not described herein again.

Optionally, the second graph convolutional layer may include a plurality of graph convolutional layers.

Optionally, a direct coupling channel may be included between the plurality of graph convolutional layers included in the second graph convolutional layer. In this way, training efficiency and stability that are of the neural network can be improved.

It should be understood that, for the same reason as the first neural network shown in FIG. 15, design and training that are of the second neural network do not depend on the antenna configurations of the two ends for receiving and transmitting the CSI. In this way, when the antenna configurations of the two ends for receiving and transmitting the CSI change, the neural network may be avoided from being redesigned and trained, and the neural network is applicable to a dynamic MIMO system and MIMO systems with different antenna configurations.

For a specific implementation of the second neural network, refer to related descriptions of the example shown in FIG. 17 below. Details are not described herein again.

S905: The network device determines third channel state information based on the second graph model.

The third channel state information is the restored first channel state information. In other words, the third channel state information includes the channel state information between the network device and the terminal device. The third channel state information indicates the CSI between the network device and the terminal device.

In a possible implementation, that the network device determines the third channel state information based on the second graph model may include: The network device determines a third channel state based on the second graph model and the transmit and receive antenna configuration information. For related descriptions of the transmit and receive antenna configuration information, refer to the related descriptions in S901 and S902. Details are not described herein again.

It should be understood that S905 may be considered as an inverse process of S901. Therefore, for an implementation in which the network device determines the third channel state based on the second graph model and the transmit and receive antenna configuration information, refer to S901. Details are not described herein again.

Further, an embodiment of the disclosure further provides possible structures of a first neural network and a second neural network. Details are described as follows:

Refer to FIG. 17. FIG. 17 is a schematic diagram 4 of a structure of a neural network according to an embodiment of the disclosure. The first neural network may include two GraphSage graph convolutional layers (including a first GraphSage graph convolutional layer and a second GraphSage graph convolutional layer), a graph pooling layer using a self-attention mechanism, and a fully coupled layer (denoted as a first fully coupled layer). The second neural network may include a fully coupled layer (denoted as a second fully coupled layer) and four GraphSage graph convolutional layers (including a third GraphSage graph convolutional layer to a sixth GraphSage graph convolutional layer). For a concatenation relationship between network layers in the first neural network and the second neural network, refer to FIG. 17. Details are not described herein again.

The following sequentially describes specific implementations of the two neural networks shown in FIG. 17.

### 1. First GraphSage Graph Convolutional Layer and Second Graphsage Graph Convolutional Layer.

A terminal device may input a first graph model into the first GraphSage graph convolutional layer, and obtain a convolved first graph model through convolution of the first

GraphSage graph convolutional layer and the second GraphSage graph convolutional layer. A calculation expression of a k^{th} GraphSage graph convolutional layer may be as follows:

$${h}_{i}^{( k )} = {W}_{1} {h}_{i}^{( k - 1 )} + {W}_{2} \times {mean}_{j ∈ N ( i )} {h}_{j}^{( k - 1 )} ,$$

where

k=1 or 2; hᵢ^{(k)} is a node embedding feature vector that is of a node i and that is output by the kth GraphSage graph convolutional layer (that is, an output result of the node i at the k^{th} layer); hᵢ^{(o)}=xᵢ, which indicates that data input into a graph convolutional layer for the first time is a feature of the node i, for example, Xj in the foregoing manner 4; {W₁, W₂} are neural network parameters (namely, to-be-learned parameters); N(i) indicates an adjacent node set of the node i, and N(i) may be determined using an adjacency matrix A; and mean_{j∈N(i)}hⱼ^{(k-1)} indicates an average value of node embedding feature vectors that are of nodes belonging to N(i) in all nodes and that are output by a (k−1)^{th} GraphSage graph convolutional layer.

Based on the foregoing expression, a relationship between nodes and a correlation between each node attribute and another node attribute may be learned through the first GraphSage graph convolutional layer and the second GraphSage graph convolutional layer, to obtain a node embedding feature vector of each node in the first graph model. It should be noted that a dimension of the node embedding feature vector may be less than a dimension (for example, 2N_{c} in S901) of an original feature. Therefore, the first GraphSage graph convolutional layer and the second GraphSage graph convolutional layer may implement preliminary channel information compression. In addition, the parameters {W₁, W₂} involved in the foregoing operation are applicable to all nodes. Therefore, the operation of this part is independent of the structure and the scale that are of the input first graph model, that is, independent of the antenna configuration.

### 2. Graph Pooling Layer Using the Self-Attention Mechanism

The terminal device may input the convolved first graph model into the graph pooling layer using the self-attention mechanism, and obtain a third graph model through pooling of the graph pooling layer using the self-attention mechanism. A processing process of the graph pooling layer using the self-attention mechanism may be considered as a down-sampling process. To be specific, only a part of nodes in the graph model and a coupling relationship between the nodes are reserved, and feature information of a node in the first graph model and topology structure information of a graph can be fully extracted. A calculation expression of the graph pooling layer using the self-attention mechanism may be as follows:

$$score = GNN ( {H}^{( 2 )} , A ) ,$$

where

A is an adjacency matrix; H⁽²⁾ is a matrix, including node embedding feature vectors that are of all nodes and that are output by the second GraphSage graph convolutional layer; and GNN(H⁽²⁾, A) represents a graph convolution operation that is based on the self-attention mechanism, that is, a score of each node is calculated, and the score may represent an importance degree of the node.

### 3. Graph Model Processing

For the third graph model obtained based on the graph pooling layer using the self-attention mechanism, the terminal device may process the third graph model according to the following formulas, to obtain a first vector:

$$idx = {top}_{s} ( score ) ,$$

$${H}^{′} = {H}_{idx}^{( 2 )} , and$$

$$y = {‖}_{i = 1}^{s} {H}^{′} ,$$

where

idx=tops(score) may indicate that indexes of s nodes with highest scores are obtained; H′=H_{idx}⁽²⁾ may indicate that node embedding feature vectors corresponding to the s nodes with the highest scores in H⁽²⁾ are obtained based on idx; and y=||ᵢ₌₁^{s}H′ may indicate that the node embedding feature vectors corresponding to the s nodes with the highest scores are enabled to re-form a vector y (that is, the first vector). s may also be referred to as a reserved dimension, and a length of an embedding feature vector may also be referred to as an embedding dimension. This is uniformly described herein, and details are not described below again.

It can be learned from the foregoing calculation expressions of the “graph pooling layer using the self-attention mechanism” and the “processing of the third graph model” that, the “graph pooling layer using the self-attention mechanism” and the “processing of the third graph model” may calculate, based on the node embedding feature vectors that are of all nodes and that are output by the second GraphSage graph convolutional layer, a score of each node by using GNN, reserve first s nodes with highest scores, to obtain the third graph model, and then splice the node embedding feature vectors of the s nodes into one first vector for subsequent compression of the fully coupled layer. It can be learned that, in comparison with the first graph model, a part of nodes are discarded in the third graph model.

A network device may further determine index information of a discarded node based on idx, and determine auxiliary information based on the index information of the discarded node. For example, it is assumed that there are 32 nodes, indexes of these nodes are sequentially 1 to 32, and s=20. In addition, it is assumed that, after processing according to the foregoing calculation expression of the graph pooling layer using the self-attention mechanism is performed, the determined idx includes 1 to 15, 20, 22, 25, 30, and 31. In this case, the terminal device may determine, based on idx, that indexes of reserved nodes include 1 to 15, 20, 22, 25, 30, and 31, and that indexes of discarded nodes include 16 to 19, 21, 23, 24, 26 to 29, and 32. In this case, the terminal device may use the indexes of 1 to 15, 20, 22, 25, 30, and 31 as the auxiliary information, to indicate the reserved nodes in the first graph model of the network device, or use the indexes of 16 to 19, 21, 23, 24, 26 to 29, and 32, to indicate the discarded nodes in the first graph model of the network device.

Optionally, the auxiliary information may further include an average value of features (that is, node embedding feature vectors) of all the discarded nodes. For example, it is assumed that discarded nodes in five nodes include a node 1 and a node 2. In this case, an average value of features of the discarded nodes is an average value of a feature of the node 1 and a feature of the node 2.

s in the calculation expression of the graph pooling layer using the self-attention mechanism may be predefined in a protocol, or may be indicated by the network device to the terminal device through signaling. This is not limited herein.

### 4. First Fully Coupled Layer

The terminal device may input, into the first fully coupled layer, the first vector obtained based on the third graph model, and obtain second channel state information through compression by the first fully coupled layer.

### 5. Second Fully Coupled Layer

The second fully coupled layer may decompress the second channel state information, to obtain a second vector. For example, the network device may decompress the second channel state information through the second fully coupled layer, and obtain the second vector based on a decompression result.

### 6. Vector Processing

For the second vector obtained based on the second fully coupled layer, the network device may convert the second vector into a fourth graph model. For example, the second fully coupled layer may output a real number vector whose length is 2sN_{c}, divide the real number vector into s sub-vectors whose lengths are 2N_{c}, and then determine the s sub-vectors as the fourth graph model. Each sub-vector is a feature of one node in the fourth graph model.

### 7. Padding Processing

For the fourth graph model obtained based on the second fully coupled layer, the network device may perform padding for a discarded node in the fourth graph model based on the auxiliary information, to obtain a fifth graph model.

Optionally, the network device may restore the discarded node in the fourth graph model based on the auxiliary information and transmit and receive antenna configuration information. Specifically, the network device may determine, based on the auxiliary information and the transmit and receive antenna configuration information, a location of the discarded node (that is, an adjacency relationship with another node) in the fourth graph model, and then the location of the discarded node is padded with a zero vector, to restore the discarded node in the fourth graph model. A quantity of dimensions of the zero vector is consistent with a quantity of dimensions of a feature of a reserved node in the fourth graph model. This padding manner may be referred to as zero padding.

If the auxiliary information further includes an average value of features of all discarded nodes, locations of these discarded nodes may be padded with the first vector by the network device, to restore the discarded nodes in the fourth graph model. The first vector is determined based on the average value of the features of all the discarded nodes, or in other words, sizes of all elements in the first vector each are the average value of the features of all the discarded nodes. A quantity of dimensions of the first vector is consistent with the quantity of dimensions of the feature of the reserved node in the fourth graph model. This padding manner may be referred to as mean padding.

In some possible embodiments, the locations of these discarded nodes may be padded with the second vector by the network device, to restore the discarded nodes in the fourth graph model. The second vector is a vector estimated based on a feature of an adjacent node, for example, the second vector is estimated by using an interpolation method. A quantity of dimensions of the second vector is consistent with the quantity of dimensions of the feature of the reserved node in the fourth graph model. This padding manner may be referred to as estimated padding.

### 8. Third GraphSage Graph Convolutional Layer to Sixth GraphSage Graph Convolutional Layer

The network device may input the fifth graph model into the third GraphSage graph convolutional layer, and obtain a second graph model through convolution of the third GraphSage graph convolutional layer to the sixth GraphSage graph convolutional layer.

For calculation expressions of the third GraphSage graph convolutional layer to the sixth GraphSage graph convolutional layer, refer to the calculation expressions of the first GraphSage graph convolutional layer and the second GraphSage graph convolutional layer. Details are not described herein again.

A first direct coupling channel may exist between an input of the third GraphSage graph convolutional layer in the second neural network and an output of a fourth GraphSage graph convolutional layer in the second neural network. In other words, data input into the third GraphSage graph convolutional layer and data output from the fourth GraphSage graph convolutional layer may be added, and then the added data is input into a fifth GraphSage graph convolutional layer. Similarly, a second direct coupling channel may exist between an input of the fifth GraphSage graph convolutional layer and an output of the sixth GraphSage graph convolutional layer. An implementation principle of the second direct coupling channel is similar to that of the first direct coupling channel, and details are not described herein again.

During actual disclosure, the four GraphSage graph convolutional layers shown in FIG. 17 may be replaced with fewer graph convolutional layers (for example, two GraphSage graph convolutional layers), or may be replaced with more graph convolutional layers (for example, six GraphSage graph convolutional layers). This is not limited herein. It has been verified that, in comparison with fewer graph convolutional layers, performance of the four GraphSage graph convolutional layers can meet a requirement; and in comparison with more graph convolutional layers, the four GraphSage graph convolutional layers are easier to train while the performance meets the requirement.

In some possible embodiments, the channel state information processing method shown in S901 to S905 is applicable to a single panel, or is applicable to multiple panels. When the method is applied to the multiple panels, the terminal device is used as an example. For each of the multiple panels, the terminal device may process channel state information through the same first neural network (where, for a specific process, refer to S901 to S903), to obtain first information corresponding to each panel, and feed back, to the network device, the first information corresponding to each panel. Certainly, the terminal device may alternatively simultaneously process channel state information on all of the multiple panels through the first neural network. For example, the terminal device determines first channel state information corresponding to all of the multiple panels, determines a first graph model corresponding to the first channel state information, obtains, through S902 and S903, first information corresponding to all the panels, and feeds back, to the network device, the first information corresponding to all the panels. It should be noted that, in the foregoing process, even if the first neural network needs to be reused for a plurality of times to process the channel state information, the first neural network does not need to be adjusted and retrained each time the first neural network is used. When the method is applied to the multiple panels, an disclosure manner of the network device is similar to an disclosure manner of the terminal device, and details are not described herein again.

Based on the method in FIG. 9, in a process in which the terminal device processes the first graph model through the first neural network, important feature information in the first graph model may be reserved, unimportant feature information in the first graph model is omitted, and the first channel state information is compressed through the first neural network, to reduce CSI feedback overheads and ensure effectiveness of CSI feedback, so that channel state information restored by the network device is closer to that of an original channel, thereby improving communication performance.

An embodiment of the disclosure further provides a method for training a first neural network and a second neural network. Details are as follows: obtaining a training dataset including a plurality of training samples, where each training sample includes one piece of fourth channel state information, and the fourth channel state information is channel state information from a network device to a terminal device; processing a plurality of pieces of fourth channel state information through the first neural network and the second neural network to obtain a plurality of pieces of fifth channel state information, where the fifth channel state information is channel state information obtained by processing the fourth channel state information through the first neural network and the second neural network; determining a loss function based on the plurality of pieces of fourth channel state information and the plurality of pieces of fifth channel state information; and determining gradients of the loss function to parameters of the first neural network and the second neural network, and updating the parameters based on the gradients until a convergence condition is met. For example, with reference to a training process shown in FIG. 4, the gradients of the loss function to the parameters of the first neural network and the second neural network may be determined, and the parameters are updated based on the gradients until the convergence condition is met.

An implementation process of processing the plurality of pieces of fourth channel state information through the first neural network and the second neural network to obtain the plurality of pieces of fifth channel state information may include: using each piece of fourth channel state information as first channel state information and performing processing through S901 and S902, to obtain first information corresponding to each piece of fourth channel state information; and performing processing through S904 and S905 after the first information corresponding to each piece of fourth channel state information is processed through S903 (that is, after channel feedback), to obtain fifth channel state information corresponding to each piece of fourth channel state information.

The foregoing training process may be performed in an offline or online manner, and the training process is not described herein again.

To verify effectiveness of the technical solutions provided in embodiments of the disclosure, simulation is further performed on the foregoing method embodiments in the disclosure. A specific simulation scenario and a simulation result are as follows:

Simulation scenario: A deep MIMO dataset is used to generate 100,000 datasets (denoted as training datasets), 30,000 datasets (denoted as validation datasets), and 10,000 datasets (denoted as test datasets) for training, verifying, and testing the foregoing neural network. These datasets are all normalized before the training. A total bandwidth of a communication system is 0.015625 gigahertz (GHz), Ñ_{c}=64, and N_{c}=32. During the simulation, an embedding dimension is set to 32, and a reserved dimension s=14.

Effect of the neural network shown in FIG. 17 is tested. When performance of compressing and restoring the first channel state information (that is, the CSI) is evaluated, the performance is evaluated using two indicators: a normalized mean square error (NMSE) and a correlation degree (ρ). The NMSE and ρ are respectively defined as:

$$NMSE = E \{ \frac{{‖ H - \hat{H} ‖}_{2}^{2}}{{‖ H ‖}_{2}^{2}} \} , and$$

$$ρ = E \{ \frac{1}{{N}_{c}} {\sum }_{n = 1}^{{N}_{c}} \frac{\vert {\hat{h}}_{n}^{H} {h}_{n} \vert}{{‖ {\hat{h}}_{n} ‖}_{2} {‖ {h}_{n} ‖}_{2}} \} ,$$

where

E{x} represents an expectation of x, and x is, for example,

$$\frac{{‖ H - \hat{H} ‖}_{2}^{2}}{{‖ H ‖}_{2}^{2}} or$$

$$\frac{1}{{N}_{c}} {\sum }_{n = 1}^{{N}_{c}} \frac{\vert {\hat{h}}_{n}^{H} {h}_{n} \vert}{{‖ {\hat{h}}_{n} ‖}_{2} {‖ {h}_{n} ‖}_{2}} ;$$

H represents an original channel matrix (that is, an actual channel matrix); Ĥ represents a channel matrix restored through compression and feedback, that is, the first channel state information restored through S901 to S905; hₙ is a vector in an n^{th} column in H; and ĥₙ is a vector in an n^{th} column in Ĥ.

A simulation test is as follows:

Test 1: The first neural network and the second neural network are trained using a dataset of Nₜ=32, and are tested in datasets with different Nₜ (a quantity of transmit antennas of the network device). Results are shown in Table 1, and Table 1 shows performance of the method shown in FIG. 9 when Nₜ changes. Refer to Table 1. It can be learned that, in the technical solutions provided in embodiments of the disclosure, when a quantity of antennas increases, restoration accuracy decreases by only about 1%. Therefore, the technical solutions provided in embodiments of the disclosure have good scalability when the quantity of antennas changes.

TABLE 1

| Nₜ | 32 | 64 | 128 | 256 | 512 |
|---|---|---|---|---|---|
| NMSE | −12.28 | −12.07 | −11.68 | −11.25 | −10.69 |
| decibel (dB) | | | | | |
| ρ | 97.39% | 97.23% | 96.92% | 96.65% | 96.17% |

Test 2: The first neural network and the second neural network are trained using a dataset whose antenna configuration is (N₁,N₂)-(32,1), and are tested in datasets with different antenna array arrangement manners. Results are shown in Table 2. Table 2 shows performance that the method shown in FIG. 9 has when an antenna array arrangement changes. It can be learned from Table 2 that, even if an antenna configuration changes, a correlation degree is still at least higher than 94%. Therefore, in the technical solutions provided in embodiments of the disclosure, the performance is stable when the antenna array arrangement manner changes.

TABLE 2

| (N₁, N₂) | (32, 1) | (16, 2) | (8, 4) |
|---|---|---|---|
| NMSE (dB) | −12.28 | −10.25 | −9.69 |
| ρ | 97.39% | 95.75% | 94.94% |

With reference to FIG. 1 to FIG. 17, the foregoing describes in detail the channel state information processing method provided in embodiments of the disclosure. With reference to FIG. 18, the following describes in detail a communication apparatus configured to perform the channel state information processing method provided in embodiments of the disclosure.

As shown in FIG. 18, an embodiment of the disclosure provides a communication apparatus 1800. The communication apparatus 1800 may be a network device or a terminal device, may be an apparatus in a network device or a terminal device, or may be an apparatus that can be used together with a network device or a terminal device. In a possible implementation, the communication apparatus 1800 may include modules or units that are in one-to-one correspondence with the methods/operations/steps/actions performed by the network device or the terminal device in the foregoing method embodiments. The unit may be a hardware circuit, or may be software, or may be implemented by a combination of a hardware circuit and software.

In a possible implementation, the communication apparatus 1800 may include a processing module 1801 and a transceiver module 1802. For ease of description, FIG. 18 shows only main components of the communication apparatus.

In some embodiments, the communication apparatus 1800 is applicable to the communication system shown in FIG. 7, to perform functions of the terminal device in the channel state information processing method shown in FIG. 9. In this case, the communication apparatus 1800 may be understood as a first communication apparatus.

The processing module 1801 is configured to determine a first graph model corresponding to first channel state information. The first channel state information is channel state information from a second communication apparatus to the first communication apparatus. The processing module 1801 is further configured to process the first graph model through a first neural network, to obtain first information. The first information is used by the second communication apparatus to restore the first channel state information. The transceiver module 1802 is configured to send the first information to the second communication apparatus.

In a possible implementation, the processing module 1801 is further configured to determine, based on transmit and receive antenna configuration information, the first graph model corresponding to the first channel state information. The transmit and receive antenna configuration information includes receive antenna configuration information of the first communication apparatus and transmit antenna configuration information of the second communication apparatus.

In a possible implementation, the first information includes auxiliary information, the auxiliary information is used to determine a second graph model, and the second graph model is used to restore the first channel state information.

Optionally, the auxiliary information includes index information of a part of nodes of the first graph model.

Further, the auxiliary information may further include an average value of features of the part of nodes.

Optionally, the first information includes second channel state information and the auxiliary information, and the second channel state information includes processed first channel state information.

Further, the first neural network may include a first pooling layer and a compression layer. The first graph pooling layer is configured to determine a third graph model and the auxiliary information based on the first graph model, and the compression layer is configured to determine the second channel state information based on the third graph model.

The first graph pooling layer may be a graph pooling layer using a self-attention mechanism.

Further, the first neural network may include a first graph convolutional layer, a first graph pooling layer, and a compression layer. The first graph convolutional layer is configured to determine a convolved first graph model based on the first graph model, the first graph pooling layer is configured to determine a third graph model and the auxiliary information based on the convolved first graph model, and the compression layer is configured to determine the second channel state information based on the third graph model.

Further, the compression layer may be a fully coupled layer.

In a possible implementation, the first channel state information includes delay-angle domain channel state information between a transmit antenna of the second communication apparatus and a receive antenna of the first communication apparatus. The delay-angle domain channel state information includes channel state information between R receiving angles and T transmitting angles, R and T are both positive integers, and at least one of R and T is greater than 1. The first graph model includes a plurality of nodes, a feature of the node includes channel state information between an i^{th} transmitting angle and a j^{th} receiving angle, 1≤i≤T, and 1≤j≤R. The first graph model further includes at least one edge. Each edge is coupled to two nodes, and each edge indicates that the two nodes coupled to the edge correspond to two adjacent receiving angles or two adjacent transmitting angles.

Optionally, the channel state information included in the feature of each node includes C elements in time domain, and C is less than or equal to a quantity of subcarriers.

In a possible implementation, the receive antenna configuration information of the first communication apparatus includes one or more of the following: a quantity of receive antennas of the first communication apparatus, a type of a receive antenna panel, and an arrangement manner of receive antenna units. The transmit antenna configuration information of the second communication apparatus includes one or more of the following: a quantity of transmit antennas of the second communication apparatus, a type of a transmit antenna panel, and an arrangement manner of transmit antenna units.

In a possible implementation, the processing module 1801 is further configured to determine the first channel state information based on space-frequency domain channel state information between the transmit antenna of the second communication apparatus and the receive antenna of the first communication apparatus. The first channel state information is delay-angle domain channel state information.

In a possible implementation, the first neural network is determined based on a training dataset, the training dataset includes a plurality of pieces of fourth channel state information for the first neural network, and the fourth channel state information is channel state information from the second communication apparatus to the first communication apparatus.

In some other embodiments, the communication apparatus 1800 is applicable to the communication system shown in FIG. 7, to perform functions of the network device in the channel state information processing method shown in FIG. 9. In this case, the communication apparatus 1800 may be understood as a second communication apparatus.

The transceiver module 1802 is configured to receive first information sent by a first communication apparatus. The first information is used by the second communication apparatus to restore first channel state information, and the first channel state information is channel state information from the second communication apparatus to the first communication apparatus. The processing module 1801 is configured to process the first information through a second neural network, to obtain a second graph model. The processing module 1801 is further configured to determine third channel state information based on the second graph model. The third channel state information is the restored first channel state information.

In a possible implementation, the processing module 1801 is further configured to determine a third channel state based on the second graph model and transmit and receive antenna configuration information. The transmit and receive antenna configuration information includes receive antenna configuration information of the first communication apparatus and transmit antenna configuration information of the second communication apparatus.

In a possible implementation, the first information includes auxiliary information, and the auxiliary information is used to determine the second graph model.

Optionally, the auxiliary information includes index information of a part of nodes of a first graph model, and the first graph model is a graph model corresponding to the first channel state information.

Further, the auxiliary information may further include an average value of features of the part of nodes.

Optionally, the first information includes second channel state information and the auxiliary information, and the second channel state information includes processed first channel state information.

Further, the second neural network may include a decompression layer and a second graph convolutional layer. The decompression layer is configured to determine a fourth graph model based on the second channel state information, and the second graph convolutional layer is configured to determine the second graph model based on the auxiliary information and the fourth graph model.

Further, the second graph convolutional layer may include a plurality of graph convolutional layers, and a direct coupling channel is included between the plurality of graph convolutional layers.

Further, the decompression layer may be a fully coupled layer.

In a possible implementation, the first channel state information includes delay-angle domain channel state information between a transmit antenna of the second communication apparatus and a receive antenna of the first communication apparatus. The delay-angle domain channel state information includes channel state information between R receiving angles and T transmitting angles, R and T are both positive integers, and at least one of R and T is greater than 1. The second graph model includes a plurality of nodes, a feature of the node includes channel state information between an i^{th} transmitting angle and a j^{th} receiving angle, 1≤i≤T, and 1≤j≤R. The second graph model further includes at least one edge. Each edge is coupled to two nodes, and each edge indicates that the two nodes coupled to the edge correspond to two adjacent receiving angles or two adjacent transmitting angles.

Optionally, the channel state information included in the feature of each node includes C elements in time domain, and C is less than or equal to a quantity of subcarriers.

In a possible implementation, the receive antenna configuration information of the first

communication apparatus includes one or more of the following: a quantity of receive antennas of the first communication apparatus, a type of a receive antenna panel, and an arrangement manner of receive antenna units. The transmit antenna configuration information of the second communication apparatus includes one or more of the following: a quantity of transmit antennas of the second communication apparatus, a type of a transmit antenna panel, and an arrangement manner of transmit antenna units.

In a possible implementation, the second neural network is determined based on a training dataset, the training dataset includes a plurality of pieces of fourth channel state information for the second neural network, and the fourth channel state information is channel state information from the second communication apparatus to the first communication apparatus.

Optionally, the transceiver module 1802 may include a receiving module and a sending module (which are not shown in FIG. 18). The sending module is configured to implement a sending function of the communication apparatus 1800, and the receiving module is configured to implement a receiving function of the communication apparatus 1800.

Optionally, the communication apparatus 1800 may further include a storage module (not shown in FIG. 18), and the storage module stores a program or instructions. When the processing module 1801 executes the program or the instructions, the communication apparatus 1800 is enabled to perform a function of the network device or the terminal device in the channel state information processing method shown in FIG. 9.

It should be understood that the processing module 1801 in the communication apparatus 1800 may be implemented by a processor or a processor-related circuit component, and may be a processor or a processing unit. The transceiver module 1802 may be implemented by a transceiver or a transceiver-related circuit component, and may be a transceiver or a transceiver unit.

In addition, for a technical effect of the communication apparatus 1800, refer to a technical effect of the channel state information processing method shown in FIG. 9. Details are not described herein again.

If the communication apparatus 1800 provided in the embodiment of the disclosure is a chip, the transceiver module 1802 in the communication apparatus 1800 may separately correspond to input and output of the chip. For example, the receiving module in the transceiver module 1802 corresponds to input of the chip, and the sending module in the transceiver module 1802 corresponds to the output of the chip. This is not limited in the disclosure.

An embodiment of the disclosure further provides a chip system, including a processor. The processor is coupled to a memory. The memory is configured to store a program or instructions. When the program or the instructions are executed by the processor, the chip system is enabled to implement the method according to any one of the foregoing method embodiments.

Optionally, there may be one or more processors in the chip system. The processor may be implemented by hardware, or may be implemented by software. When the processor is implemented by the hardware, the processor may be a logic circuit, an integrated circuit, or the like. When the processor is implemented by the software, the processor may be a general-purpose processor, and is implemented by reading software code stored in the memory.

Optionally, there may alternatively be one or more memories in the chip system. The memory may be integrated with the processor, or may be disposed separately from the processor. This is not limited in the disclosure. For example, the memory may be a non-transitory processor, for example, a read-only memory ROM. The memory and the processor may be integrated into a same chip, or may be separately disposed on different chips. A type of the memory and a manner of disposing the memory and the processor are not specifically limited in the disclosure.

For example, the chip system may be a field programmable gate array (FPGA), an ASIC, a system on a chip (SoC), a CPU, a network processor (NP), a digital signal processor (DSP), a microcontroller unit (MCU), a programmable controller (PLD), or another integrated chip.

An embodiment of the disclosure provides a communication system. The communication system includes a network device and a terminal device. The network device and the terminal device may be combined to perform the foregoing method embodiments. For a specific execution process, refer to the foregoing method embodiments. Details are not described herein again.

The disclosure further provides a computer-readable storage medium. The computer-readable storage medium stores a computer program. When the computer-readable storage medium is executed by a computer, a function of any one of the foregoing method embodiments is implemented.

The disclosure further provides a computer program product. When the computer program product is executed by a computer, a function of any one of the foregoing method embodiments is implemented.

It should be understood that the processor in embodiments of the disclosure may be a CPU, or the processor may be another general-purpose processor, a DSP, an ASIC, an FPGA or another programmable logic device, a discrete gate or a transistor logic device, a discrete hardware component, or the like. The general-purpose processor may be a microprocessor, or the processor may be any conventional processor or the like.

It may be understood that the memory in embodiments of the disclosure may be a volatile memory or a non-volatile memory, or may include a volatile memory and a non-volatile memory. The non-volatile memory may be a ROM, a programmable read-only memory (PROM), an erasable programmable read-only memory (EPROM), an EEPROM, or a flash memory. The volatile memory may be a RAM, which serves as an external cache. Through example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus dynamic random access memory (DR RAM).

All or some of the foregoing embodiments may be implemented by software, hardware (for example, a circuit), firmware, or any combination thereof. When the software is used for implementing embodiments, the foregoing embodiments may be implemented completely or partially in a form of a computer program product. The computer program product includes one or more computer instructions or computer programs. When the computer instructions or the computer programs are loaded and executed on the computer, the procedure or functions according to embodiments of the disclosure are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

In the specification, claims, and accompanying drawings of the disclosure, the terms “first”, “second”, “third” and the like are intended to distinguish between different objects but do not limit a particular sequence.

It should be understood that the term “and/or” in this specification describes only an association relationship between associated objects and represents that three relationships may exist. For example, A and/or B may represent the following three cases: Only A exists, both A and B exist, and only B exists. A and B may be singular or plural. In addition, the character “/” in this specification usually indicates an “or” relationship between the associated objects, but may alternatively indicate an “and/or” relationship. For details, refer to the context for understanding.

In the disclosure, “at least one” means one or more, and “a plurality of” means two or more. At least one of the following items (pieces) or a similar expression thereof indicates any combination of these items, including a single item (piece) or any combination of a plurality of items (pieces). For example, at least one item (piece) of a, b, or c may represent: a, b, c, a and b, a and c, b and c, or a, b, and c, where a, b, and c may be singular or plural.

It should be understood that sequence numbers of the foregoing processes do not mean execution sequences in various embodiments of the disclosure. The execution sequences of the processes should be determined based on functions and internal logic of the processes, and should not be construed as any limitation on the implementation processes of embodiments of the disclosure.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular disclosures and design constraints of the technical solutions. A person skilled in the art may use different methods to implement the described functions for each particular disclosure, but it should not be considered that the implementation goes beyond the scope of the disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in the disclosure, it should be understood that the disclosed system, apparatus, and method may be implemented in other manners. For example, the described apparatus embodiment is merely an example. For example, division into the units is merely logical function division and may be another division manner during actual implementation. For example, a plurality of units or components may be combined or integrated into another system, or some features may be ignored or not performed. In addition, the displayed or discussed mutual couplings or direct couplings or communication couplings may be implemented through some interfaces. The indirect couplings or communication connections between the apparatuses or units may be implemented in electrical, mechanical, or other forms.

The units described as separate parts may or may not be physically separate, and parts

displayed as units may or may not be physical units, may be located in one position, or may be distributed on a plurality of network units. Some or all of the units may be selected based on actual requirements to achieve the objectives of the solutions of embodiments.

In addition, functional units in embodiments of the disclosure may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the disclosure may be implemented in a form of a software product. The computer software product is stored in a storage medium, and includes several instructions used for instructing a computer device (which may be a personal computer, a server, a network device, or the like) to perform all or some of the steps of the method described in embodiments of the disclosure. The foregoing storage medium includes any medium, such as a USB flash drive, a removable hard disk, a ROM, a RAM, a magnetic disk, or an optical disc, that can store program code.

The foregoing descriptions are merely specific implementations of the disclosure, but are not intended to limit the protection scope of the disclosure. Any variation or replacement readily figured out by a person skilled in the art within the technical scope disclosed in the disclosure shall fall within the protection scope of the disclosure. Therefore, the protection scope of the disclosure shall be subject to the protection scope of the claims.

What is claimed is:

1. A channel state information processing method implemented by a first communication apparatus, comprising:
determining a first graph model corresponding to first channel state information, wherein the first channel state information is channel state information from a second communication apparatus to the first communication apparatus;
processing the first graph model through a first neural network, to obtain first information, wherein the first information is for the second communication apparatus to restore the first channel state information; and
sending the first information to the second communication apparatus.

2. The method according to claim 1, further comprising:
determining based on transmit and receive antenna configuration information, the first graph model corresponding to the first channel state information, wherein the transmit and receive antenna configuration information comprises receive antenna configuration information of the first communication apparatus and transmit antenna configuration information of the second communication apparatus.

3. The method according to claim 1, where the first information comprises auxiliary information associated with a second graph model.

4. The method according to claim 3, wherein the auxiliary information comprises index information of a part of nodes of the first graph model.

5. The method according to claim 4, wherein the auxiliary information further comprises an average value of features of the part of nodes.

6. The method according to claim 3, wherein the first information comprises second channel state information and the auxiliary information, and the second channel state information comprises processed first channel state information.

7. The method according to claim 6, wherein the first neural network comprises a first graph pooling layer and a compression layer,
wherein the first graph pooling layer is configured to determine a third graph model and the auxiliary information based on the first graph model, and
wherein the compression layer is configured to determine the second channel state information based on the third graph model.

8. The method according to claim 6, wherein the first neural network comprises a first graph convolutional layer, a first graph pooling layer, and a compression layer,
wherein the first graph convolutional layer is configured to determine a convolved first graph model based on the first graph model,
wherein the first pooling layer is configured to determine a third graph model and the auxiliary information based on the convolved first graph model, and
wherein the compression layer is configured to determine the second channel state information based on the third graph model.

9. The method according to claim 7, wherein the first graph pooling layer is a graph pooling layer based on a self-attention mechanism.

10. The method according to claim 7, wherein the compression layer is a fully coupled layer.

11. The method according to claim 1, wherein the first channel state information comprises delay-angle domain channel state information between a transmit antenna of the second communication apparatus and a receive antenna of the first communication apparatus, the delay-angle domain channel state information comprises channel state information between R receiving angles and T transmitting angles, R and T are both positive integers, and at least one of R or T is greater than 1,
wherein the first graph model comprises a plurality of nodes, a feature of the node comprises channel state information between an i^{th} transmitting angle and a j^{th} receiving angle, 1≤i≤T, and 1≤j≤R,
wherein the first graph model further comprises at least one edge, and wherein each edge is coupled to two nodes, and each edge indicates that the two nodes coupled to the edge correspond to two adjacent receiving angles or two adjacent transmitting angles.

12. The method according to claim 11, wherein the channel state information comprised in the feature of each of the plurality of nodes comprises C elements in time domain, and C is less than or equal to a quantity of subcarriers.

13. The method according to claim 1, wherein the receive antenna configuration information of the first communication apparatus comprises one or more of the following: a quantity of receive antennas of the first communication apparatus, a type of a receive antenna panel, or an arrangement manner of receive antenna units, and
wherein the transmit antenna configuration information of the second communication apparatus comprises one or more of the following: a quantity of transmit antennas of the second communication apparatus, a type of a transmit antenna panel, or an arrangement manner of transmit antenna units.

14. The method according to claim 1, further comprising:
determining the first channel state information based on space-frequency domain channel state information between the transmit antenna of the second communication apparatus and the receive antenna of the first communication apparatus, wherein the first channel state information is delay-angle domain channel state information.

15. The method claim 1, wherein the first neural network is determined based on a training dataset, the training dataset comprises a plurality of pieces of fourth channel state information for the first neural network, and the fourth channel state information is channel state information from the second communication apparatus to the first communication apparatus.

16. A communication apparatus, comprising:
one or more processors configured to
determine a first graph model corresponding to first channel state information, wherein the first channel state information is channel state information from another communication apparatus to the communication apparatus;
process the first graph model through a first neural network, to obtain first information, wherein the first information is for the another communication apparatus to restore the first channel state information; and
send the first information to the another communication apparatus.

17. The communication apparatus according to claim 16, wherein the one or more processors are further configured to:
determine based on transmit and receive antenna configuration information, the first graph model corresponding to the first channel state information, wherein the transmit and receive antenna configuration information comprises receive antenna configuration information of the communication apparatus and transmit antenna configuration information of the another communication apparatus.

18. The communication apparatus according to claim 16, wherein the first information comprises auxiliary information associated with a second graph model.

19. The communication apparatus according to claim 18, wherein the auxiliary information comprises index information of a part of nodes of the first graph model.

20. A non-transitory computer-readable storage medium, storing computer programming instructions, wherein when the computer programming instructions are executed by one or more processors in a communication apparatus, cause the communication apparatus to:
determine a first graph model corresponding to first channel state information, wherein the first channel state information is channel state information from another communication apparatus to a communication apparatus coupled with the computer;
process the first graph model through a first neural network, to obtain first information, wherein the first information is used by the another communication apparatus to restore the first channel state information; and
send the first information to the another communication apparatus.
